(19) United States
(12) Patent Application Publication
(10) Pub. No.: US 2012/0201505 A1
(43) Pub. Date: Aug. 9, 2012

(54) IMAGE REPRODUCING APPARATUS AND IMAGE REPRODUCING METHOD THEREOF

(75) Inventor: Yohei Fujitani, Kawasaki-shi (JP)

(73) Assignee: CANON KABUSHIKI KAISHA, Tokyo (JP)

(21) Appl. No.: 13/362,506

(22) Filed: Jan. 31, 2012

(30) Foreign Application Priority Data
Feb. 3, 2011 (JP) 2011-022107

(51) Int. Cl. H04N 5/93; H04N 5/775

(52) U.S. Cl. 386/230; 386/E05.028

(57) ABSTRACT

In an image reproducing apparatus capable of performing group reproduction, a related image determination unit determines whether an image read by an image reading unit is an image included in a plurality of related images, which are related to each other, and if it is determined by the related image determination unit that the image read by the image reading unit is an image included in the plurality of related images, a representative image detection unit detects a representative image from a plurality of images constituting the plurality of related images including the read image, and a display processing unit causes a display unit to display the representative image detected by the representative image detection unit.

### BACKGROUND OF THE INVENTION

1. Field of the Invention

The present invention relates to an image reproducing apparatus, an image reproducing method thereof, and a program.

2. Description of the Related Art

Recently, a camera employing an image sensor including of a semiconductor such as a charge-coupled device (CCD) is becoming widely used in place of a camera employing silver-halide film. Such a camera, which is on the market as a digital camera, electronically records image data on a recording medium and displays an image on a display device, e.g., a liquid crystal display (LCD). Some digital cameras include a continuous shooting function, generally referred to as continuous shooting, and are thus capable of recording a series of pieces of related image data.

The digital camera may perform a series of shooting operation, capture a plurality of pieces of image data as image data related to each other, and record the image data on the recording medium. Japanese Patent Application Laid-Open No. 2007-221769 discusses a method for setting, in the above-described case, a plurality of pieces of image data that has been recorded as related image data, and identifying and recording a representative image among the pieces of related image data. Such a digital camera can display only the representative image among the pieces of related image data and reproduce the representative image without displaying the other images of the pieces of related image data.

Further, in recent years, the recording capacity of a recording medium has increased to enable a large number of images to be recorded. Japanese Patent Application Laid-Open No. 2005-223536 discusses a technique for displaying, to allow a user to easily view such a large number of recorded images, a total number of images or a serial number of each displayed image.

Such a digital camera displays information stored in the recording medium along with the image, to allow the user to easily view the image recorded on the recording medium using an electronic viewfinder, e.g., a color LCD. However, as the recording capacity of a recording medium increases and the number of pieces of recorded image data or the number of recording directories increase, it becomes time consuming to search information stored in the recording medium and to generate a display list. It thus requires a long time for the user to become able to start viewing images.

In particular, if the digital camera is to reproduce and display only a representative image among pieces of related image data, it becomes necessary for identifying the representative image to analyze all of the images stored in the recording medium and the relationship between the images. Thus, it is more time consuming to complete all of the analysis processes.

### SUMMARY OF THE INVENTION

According to an aspect of the present invention, an image reproducing apparatus includes an image reading unit configured to read an image from a recording unit, a display processing unit configured to cause a display unit to display the image read by the image reading unit, a related image determination unit configured to determine whether the image read by the image reading unit is an image included in a plurality of related images, which are related to each other, a representative image detection unit configured to detect a representative image from the plurality of related images, a group reproduction setting unit configured to set group reproduction for reproducing only a representative image among the plurality of related images, wherein, if the group reproduction is not set by the group reproduction setting unit, the display processing unit reproduces images read by the image reading unit, including images other than the representative image, and wherein, if the group reproduction is set by the group reproduction setting unit, the related image determination unit determines whether the image read by the image reading unit is an image included in the plurality of related images, the representative image detection unit detects, when it is determined by the related image determination unit that the image read by the image reading unit is an image included in the plurality of related images, a representative image from a plurality of images constituting the plurality of related images including the read image, and the display processing unit causes the display unit to display the representative image detected by the representative image detection unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is an external view illustrating a digital camera according to an exemplary embodiment of the present invention.

FIG. 2 is a block diagram illustrating a configuration of the digital camera.

FIG. 3 is a flowchart illustrating an overall operation of the digital camera.

FIG. 4 is a flowchart illustrating a process performed in a shooting mode.

FIG. 5 is a flowchart illustrating a shooting process.

FIG. 6 is a flowchart illustrating a recording process.

FIG. 7 illustrates a tree structure in a recording medium.

FIG. 8 illustrates a file structure of image data.

FIG. 9 is a flowchart illustrating a process performed in a reproduction mode.

FIG. 10 is a flowchart illustrating an initial image information acquisition process.

FIG. 11 is a flowchart illustrating a representative image detection process.

FIG. 12, which is composed of FIGS. 12A and 12B, is a flowchart illustrating a reproduction input waiting process.

FIG. 13 is a flowchart illustrating a file analysis process.

FIG. 14 is a flowchart illustrating a search list generation process.

FIG. 15 illustrates a tree structure in a recording medium.

FIG. 16 is a flowchart illustrating a reliability verification process.

FIG. 17 illustrates an example of a search management file structure.

FIG. 18 is a flowchart illustrating a search management file generation process.

FIG. 19 is a flowchart illustrating an attribute information acquisition process.

FIG. 20 is a flowchart illustrating an image display process.

FIG. 21 is a flowchart illustrating a representative image selection process.

FIG. 22 is a flowchart illustrating a next representative image selection process.

### DESCRIPTION OF THE EMBODIMENTS

Various exemplary embodiments, features, and aspects of the invention will be described in detail below with reference to the drawings.

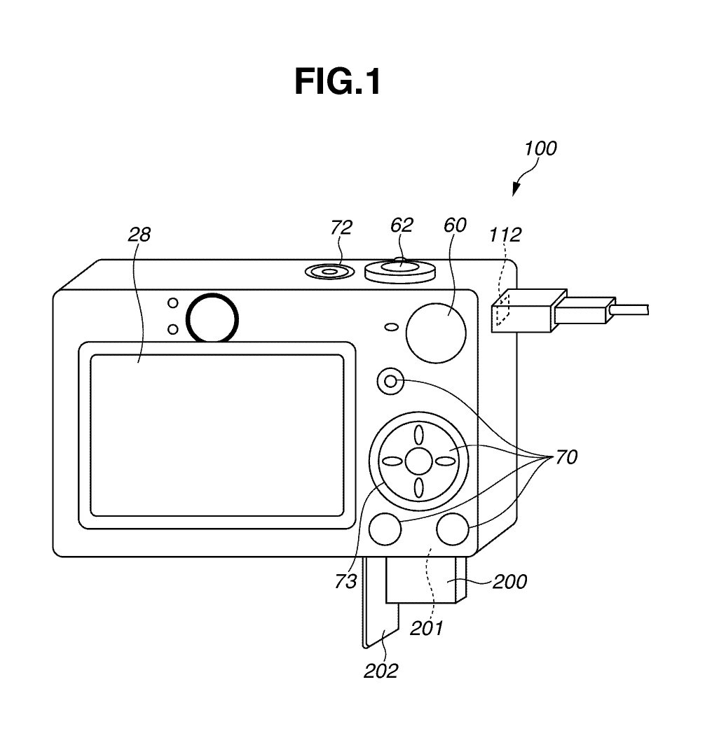

FIG. 1 is an external view illustrating a digital camera 100 as an example of an image reproducing apparatus according to an exemplary embodiment of the present invention. Referring to FIG. 1, the digital camera 100 includes an image display unit 28, an operation unit 70, a mode switch 60, a shutter switch 62, a power switch 72, a controller wheel 73, and a connector 112.

The image display unit (i.e., a display unit) 28 displays an image and various information. The operation unit 70 includes switches, buttons, and a touch panel for receiving various operations from the user. The operation unit 70 may include the mode switch 60 and the shutter switch 62.

The mode switch 60 is used for switching between various modes. The shutter switch 62 is used by the user to issue a shooting instruction to the digital camera 100. The controller wheel 73, which is a rotatable button, is used by the user to issue instructions to the digital camera 100. The power switch 72 is a switch for switching between power on and power off. The connector 112 is a connecting unit, to which a connection cable can be connected.

Further, the digital camera 100 includes a recording medium slot 201 and a slot cover 202 as an attachment unit. The recording medium slot 201 can store a recording medium 200 such as a memory card or a hard disk. The recording medium 200 stored in the recording medium slot 201 can communicate with the digital camera 100. A semiconductor memory or a magnetic disk can also be used as the recording medium 200.

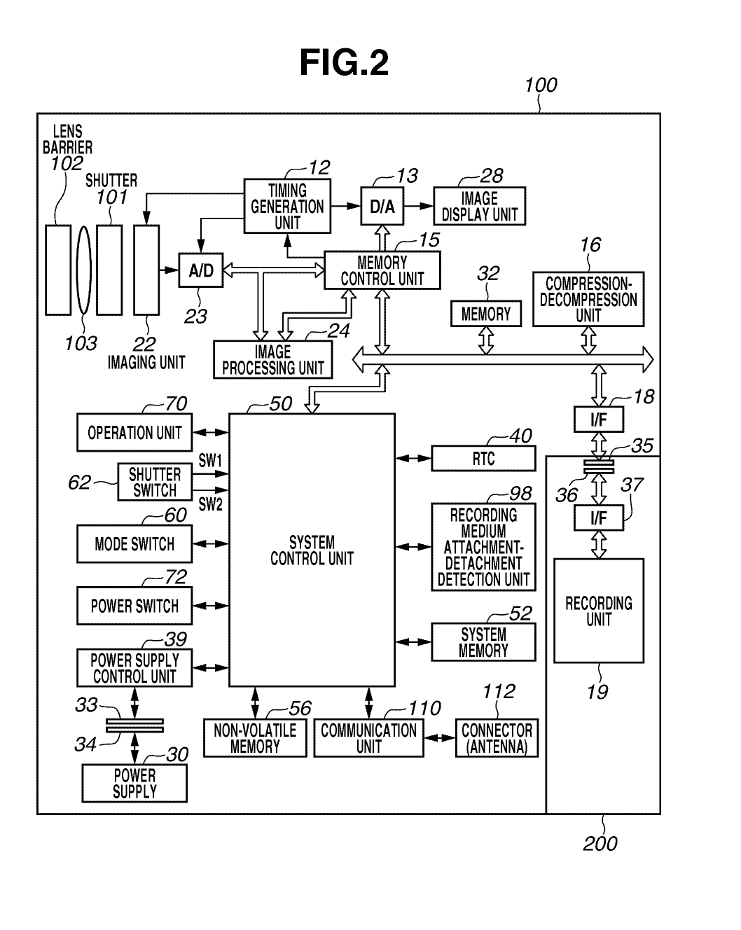

FIG. 2 is a block diagram illustrating an example of a configuration of the digital camera. Referring to FIG. 2, the digital camera 100 includes a photographic lens 103, a shutter 101, an imaging unit 22, and a lens barrier 102. The photographic lens 103 includes a focus lens. The shutter 101 includes a diaphragm function. The imaging unit 22 includes a CCD or a complementary metal-oxide semiconductor (CMOS) sensor, which converts an optical image to an electric signal. The lens barrier 102 covers the photographic lens 103 to prevent soiling or damaging of an optical imaging system, including the photographing lens 103, the shutter 101, and the imaging unit 22.

Further, the digital camera 100 includes an analog-digital (A/D) converter 23, a timing generation unit 12, an image processing unit 24, a memory control unit 15, a system control unit 50, a memory 32, a D/A converter 13, the image display unit 28, a non-volatile memory 56, and a system memory 52. The A/D converter 23 converts an analog signal output from the imaging unit 22 or a sound control unit (not illustrated) to a digital signal. The timing generation unit 12 is controlled by the memory control unit 15 and the system control unit 50.

The image processing unit 24 performs, with respect to the data received from the A/D converter 23 or the memory control unit 15, predetermined resizing processing, such as pixel interpolation and reduction, and color conversion. Further, the image processing unit 24 performs predetermined calculation processing on captured image data, and the system control unit 50 performs exposure control and focusing control based on the acquired calculation result. As a result, the digital camera 100 performs through-the-lens (TTL) type auto-focus processing (AF), auto-exposure (AE) processing, and electronic flash pre-emission (EF). Furthermore, the image processing unit 24 performs predetermined calculation processing on the captured image data, and performs TTL-type auto-white balance (AWB) processing based on the calculation result.

The data output from the A/D converter 23 is written in the memory 32 via the image processing unit 24 and the memory control unit 15, or directly via the memory control unit 15. The memory 32 has a sufficient storage capacity for storing a predetermined number of still images, moving images of a predetermined period of time, and audio data of a predetermined period of time. The memory 32 is also used for displaying images.

A compression-decompression unit 16 compresses or decompresses image data with adaptive discrete cosine transform (ADCT). Further, the compression-decompression unit 16 is triggered by the shutter 101 to read and compress the captured image stored in the memory 32, and writes the compressed data in the memory 32. Furthermore, the compression-decompression unit 16 reads and decompresses the compressed image read from the recording unit 19 to the memory 32, and writes the decompressed data in the memory 32. A file unit of the system control unit 50 converts into files the image data which has been written in the memory 32 by the compression-decompression unit 16, and the files are then recorded on the recording medium 200 via an interface 18.

The image display unit 28, such as an LCD, displays via the D/A converter 13 the image data to be displayed written in the memory 32. The system control unit 50 functions as a computer and controls the digital camera 100. The system memory 52 stores constants, variables, and programs for the system control unit 50 to operate. The non-volatile memory 56 is an electrically erasable and recordable memory, such as an electrically erasable programmable read-only memory (EEPROM).

Furthermore, the digital camera 100 includes operation input units for inputting various operation instructions to the system control unit 50. The operation input units include a shutter switch SW1, a shutter switch SW2, the mode switch 60, the operation unit 70, and the power switch 72. The shutter switch SW1 is switched on when the user operates halfway on (i.e., half-presses) the shutter switch 62. The shutter switch SW1 then instructs the digital camera 100 to start operations of AF processing, AE processing, AWB processing, and EF processing. The shutter switch SW2 is switched on when the user completes operating on (i.e., fully presses) the shutter switch 62. The shutter switch SW2 then instructs the digital camera 100 to start a series of imaging processes, from the imaging unit 22 reading the signal, to writing the image data in the recording medium 200. The mode switch 60 is used to switch an operation mode of the system control unit 50 to either of a still image shooting mode, a continuous shooting mode, a moving image mode, or a reproduction mode.

The operation unit 70 includes various buttons and a touch panel. More specifically, the operation unit 70 includes a delete button, a menu button, a set button, a cross-shaped four-way key, and a print reservation button, which realizes a print function on a printer connected to the connector 112. If the user presses the menu button, the image display unit 28 displays a menu screen on which various settings can be specified. The user can thus intuitively specify various settings using the menu screen displayed on the image display unit 28, the four-way key, and the set button. Further, the operation unit 70 includes a refinement button, a group reproduction button, and a resume reproduction button to be described below. The power switch 72 is used to switch between power on and off.

Moreover, the digital camera 100 includes a power supply control unit 39, a power supply 30, and connectors 33 and 34. The power supply control unit 39 includes a battery detection circuit, a direct current (DC)-DC convertor, and a switch circuit for switching a block to be energized. The power supply control unit 39 thus detects whether the battery is attached, a type of the battery, and a remaining amount of the battery. Further, the power supply control unit 39 controls the DC-DC convertor based on the detection result and the instruction from the system control unit 50, and supplies a necessary voltage for a necessary period of time to each unit including the recording medium 200.

The power supply 30 includes primary batteries such as an alkaline battery and a lithium battery, a secondary battery such as a nickel-cadmium (NiCd) battery, a nickel-metal halide (NiMH) battery, and a lithium (Li) battery, and an alternating current (AC) adaptor. The connectors 33 and 34 connect the power supply 30 and the power supply control unit 39.

Further, the digital camera 100 includes a real time clock (RTC) 40, a recording medium attachment-detachment detection unit 98, a communication unit 110, the connector 112, the interface 18, and a connector 35. The RTC 40 contains a power supply unit separately from the power supply control unit 39, and can continue a clock operating state even when the power supply 30 is switched off. The system control unit 50 performs timer control using the date and time acquired by the RTC 40 when the digital camera 100 is activated. The recording medium attachment-detachment detection unit 98 detects whether the recording medium 200 is attached to the connector 35.

The communication unit 110 performs various communication by the recommended standard 232 version C (RS232C), universal serial bus (USB), Institute of Electrical and Electronics Engineers (IEEE) 1394, parallel (P) 1284, small computer system interface (SCSI), modem, local area network (LAN), and wireless communication. The connector (or an antenna in the case of wireless communication) 112 connects the digital camera 100 to other devices via the communication unit 110. The connector 112 is connected to a printer, and in such a case, the digital camera 100 transfers the image file recorded in the recording medium 200 to the printer, so that the image can be directly printed by the printer without using a personal computer (PC). The interface 18 connects the recording medium 200 to the digital camera 100. The connector 35 connects the recording medium 200 to the interface 18.

The recording medium 200 includes a recording unit 19, such as a semiconductor memory and a magnetic disk, an interface 37 to the digital camera 100, and a connector 36 for connecting the recording medium 200 to the digital camera 100.

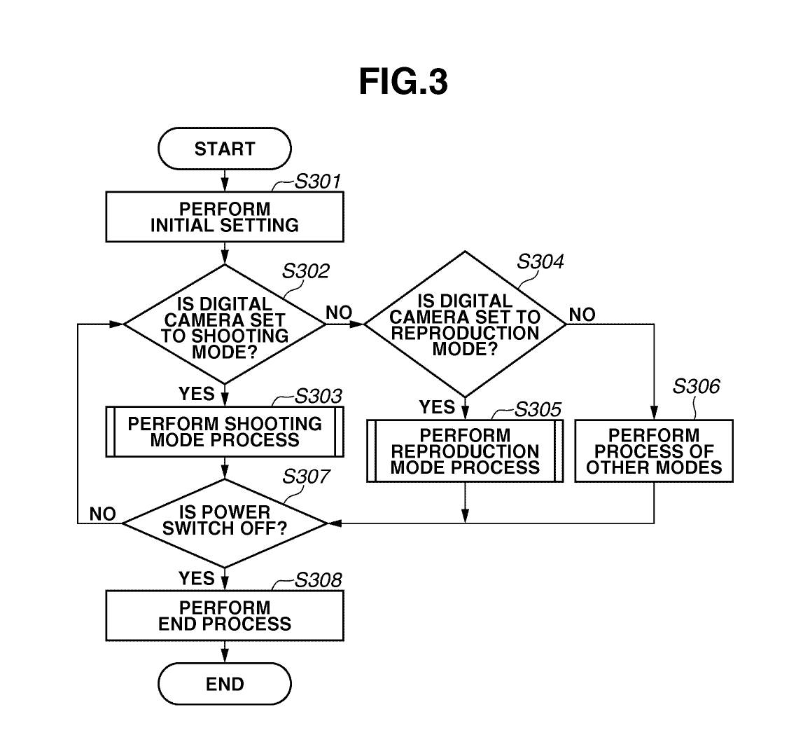

An overall operation of the digital camera 100 according to the present exemplary embodiment will be described below with reference to a flowchart illustrated in FIG. 3. The processes illustrated in the flowcharts to be described below including the flowchart illustrated in FIG. 3 are realized by the system control unit 50 reading a program stored in the memory 32 and performing calculations and control.

In step S301 illustrated in FIG. 3, the user operates the power switch 72 to switch the power on, and the system control unit 50 initializes flags and control variables. In step S302, the system control unit 50 determines a setting position of the mode switch 60. If the mode switch is set to the shooting mode (YES in step S302), the process proceeds to step S303. If the mode switch is set to a mode other than the shooting mode (NO in step S302), the process proceeds to step S304. The shooting mode process performed in step S303 will be described in detail below.

In step S304, the system control unit 50 determines whether the mode switch 60 is set to the reproduction mode. If the mode switch 60 is set to the reproduction mode (YES in step S304), the process proceeds to step S305. If the mode switch 60 is set to a mode other than the reproduction mode (NO in step S304), the process proceeds to step S306. The reproduction mode process performed in step S305 will be described in detail below.

In step S306, the system control unit 50 performs a process according to the selected mode, and the process then proceeds to step S307. The other modes include a communication mode in which the digital camera 100 transmits and receives files in the recording medium 200.

In step S307, the system control unit 50 determines the setting position of the power switch 72. If the power switch is 72 set to “power on” (NO in step S307), the process returns to step S302. If the power switch 72 is set to “power off” (YES in step S307), the process proceeds to step S308.

In step S308, the system control unit 50 performs a predetermined end process. More specifically, the system control unit 50 changes the display on the image display unit 28 to an end state, and closes the lens barrier 102 to protect the imaging unit 22. Further, the system control unit 50 records, in the non-volatile memory 56, parameters and setting values including the flags and the control variables, and the setting mode. The system control unit 50 then interrupts supplying power to portions in which it is not necessary to supply the power.

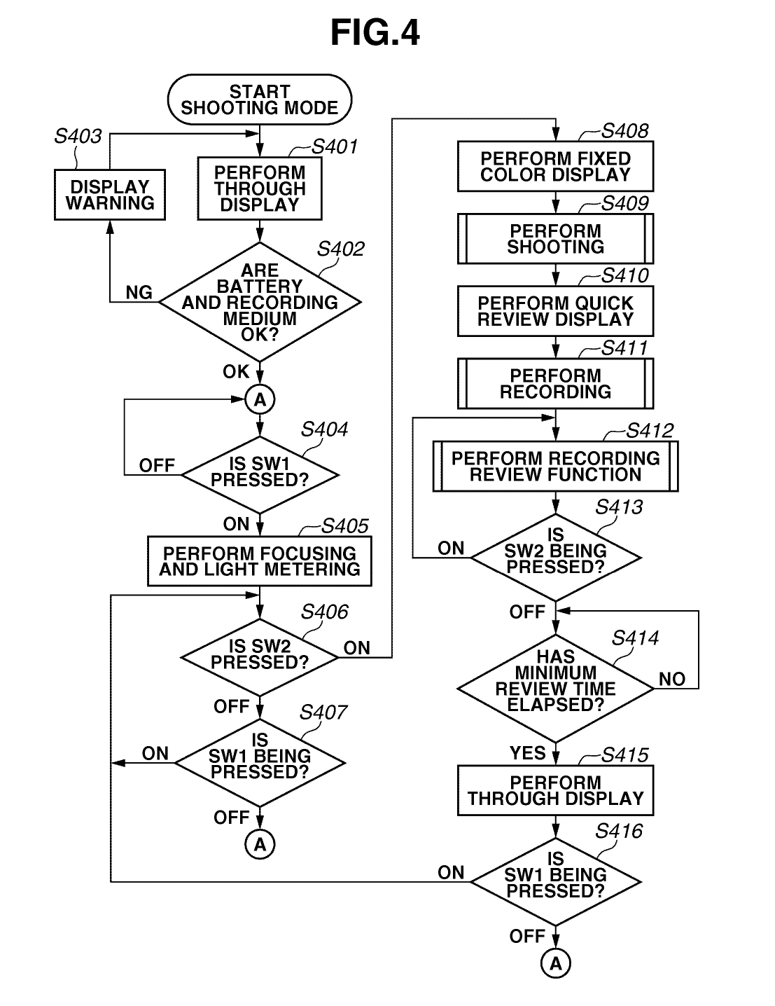

FIG. 4 is a flowchart illustrating a process performed in the shooting mode.

Upon start of the shooting mode, in step S401, the system control unit 50 performs through-display on the image display unit 28. In step S402, the system control unit 50 determines, using the power supply control unit 39, a remaining power level of the power supply 30, and the presence or absence and the remaining capacity of the recording medium 200. The system control unit 50 then determines whether the remaining power level of the power supply 30, or the presence or absence or the remaining capacity of the recording medium 200 has an adverse effect on the operation of the digital camera 100.

If there is an adverse effect (NG in step S402), the process proceeds to step S403. In step S403, the system control unit 50 outputs via the image display unit 28 a predetermined warning using an image or an audio message. The process then returns to step S401. On the other hand, if there is no adverse effect (OK in step S402), the process proceeds to step S404.

In step S404, the system control unit 50 determines whether the user has pressed the shutter switch SW1. If the user has pressed the shutter switch SW1 (ON in step S404), the process proceeds to step S405. If the user has not pressed the shutter switch SW1 (OFF in step S404), the system control unit 50 waits for the user to press the shutter switch SW1.

In step S405, the system control unit 50 performs focusing to focus the photographing lens 103 on an object. Further, the system control unit 50 performs light metering, to determine an aperture value and a shutter time. The system control unit 50 sets the flash as necessary in performing light metering.

In step S406, the system control unit 50 determines whether the user has pressed the shutter switch SW2. If the user has pressed the shutter switch SW2 (ON in step S406), the process proceeds to step S408. If the user has not pressed the shutter switch SW2 (OFF in step S406), the process proceeds to step S407. In step S407, the system control unit 50 determines whether the user is pressing the shutter switch SW1. If the user has stopped pressing the shutter switch SW1 (OFF in step S407), the process returns to step S404.

In step S408, the system control unit 50 sets the display state of the image display unit 28 to a fixed color display state. In step S409, the system control unit 50 performs the shooting process to be described in detail below.

In step S410, the system control unit 50 performs quick review display of the captured image on the image display unit 28. In step S411, the system control unit 50 then records as an image file on the recording medium 200 the image data acquired by performing the shooting process. The process then proceeds to step S412. The recording process will be described in detail below.

In step S412, the system control unit 50 continues to perform quick review display (i.e., a recording-review function) until the user has stopped pressing the shutter switch SW2. The user can thus easily confirm the captured image.

In performing the recording-review function, the system control unit 50 displays an image similarly as in the quick review display performed in step S410 described above. However, the system control unit 50 enlarges and displays the image in the recording-review function. The system control unit 50 thus uses the recording image employed in the recording process performed in step S411 as an image to be displayed. For example, the system control unit 50 enlarges the captured image according to a setting on an enlarge/reduce button with respect to the captured image (not illustrated). Since a high-resolution recording image is used as a display image, the user can confirm the details of the image similarly as in the recording image even when the captured image is enlarged and displayed.

In step S413, the system control unit 50 determines whether the user is pressing the shutter switch SW2. If the user has stopped pressing the shutter switch SW2 when the recording process in step S411 has ended (OFF in step S413), the process proceeds to step S414. Further, if the user continues pressing the shutter switch SW2 to continue the quick review display, and then stops pressing the shutter switch SW2 after confirming the captured image, the process proceeds to step S414.

In step S414, the system control unit 50 determines whether a predetermined minimum review time has elapsed. If the minimum review time has elapsed (YES in step S414), the process proceeds to step S415. If the minimum review time has not elapsed (NO in step S414), the system control unit 50 waits for the minimum review time to elapse.

In step S415, the system control unit 50 sets the display state of the image display unit 28 to a through-display state. In such a case, after the user has confirmed the captured image by the quick review display on the image display unit 28, the image display unit 28 can be changed to the through-display state in which the captured image data is sequentially displayed to prepare for the next shooting operation.

In step S416, the system control unit 50 determines whether the user has stopped pressing the shutter switch SW1. If the user is pressing the shutter switch SW1 (ON in step S416), the process returns to step S406, and the system control unit 50 prepares for the next shooting operation. If the user has stopped pressing the shutter switch SW1 (OFF in step S416), the system control unit 50 ends a series of shooting operation. The process then proceeds to step S404 to a shooting standby state.

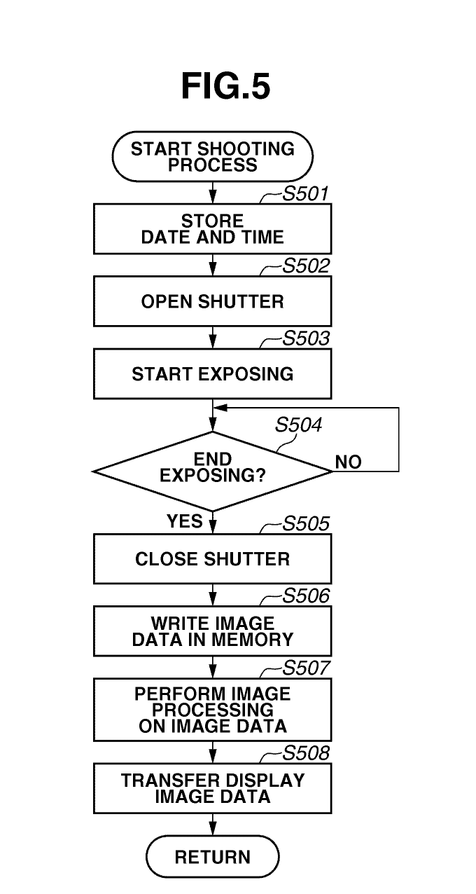

FIG. 5 is a flowchart illustrating the shooting process performed in step S409 illustrated in FIG. 4.

In step S501, the system control unit 50 acquires from the RTC 40 and stores in the system memory 52 the date and time at which the shooting operation is to be started. In step S502, the system control unit 50 releases the shutter 101 having the diaphragm function according to the aperture value, based on light metering data stored in the system memory 52 or the memory 32. In step S503, the system control unit 50 exposes the image sensor in the imaging unit 22.

In step S504, the system control unit 50 waits for the exposure of the imaging unit 22 to end according to the light metering data. In step S505, the system control unit 50 closes the shutter 101. In step S506, the system control unit 50 reads out an electric charge signal from the imaging unit 22, and then writes the captured image data in the memory 32 via the A/D converter 23, the image processing unit 24, and the memory control unit 15.

In step S507, the system control unit 50 uses the memory control unit 15 and as necessary the image processing unit 24 to read the image data written in the memory 32 and perform image processing on the image data, such as compression via the compression-decompression unit 16. The system control unit 50 then writes in the memory 32 the image data on which image processing has been performed.

In step S508, the system control unit 50 reads the image data from the memory 32, and transfers the image data to be displayed via the memory control unit 15 for performing the above-described quick review and recording review display. Upon performing the above-described series of shooting processes, the process returns to step S409 illustrated in FIG. 4.

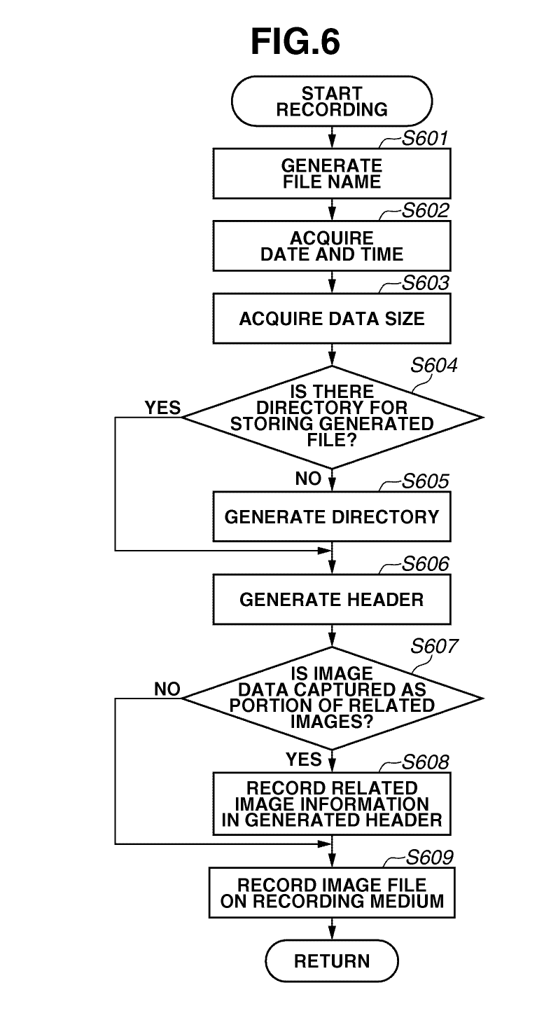

FIG. 6 is a flowchart illustrating the recording process performed in step S411 of the shooting mode process illustrated in FIG. 4. The process for recording the image data generated in the above-described shooting process will be described with reference to the flowchart illustrated in FIG. 6.

In step S601, the system control unit 50 generates a file name according to a predetermined file name generation rule. According to the present exemplary embodiment, the file name is generated by adding “1” to a maximum file number among the image files recorded on the recording medium 200. The image file thus becomes newer as the file number of the image becomes larger in a normal use. In step S602, the system control unit 50 acquires the date and time information stored in the system memory 52 in step S501 of the shooting process illustrated in FIG. 5. In step S603, the system control unit 50 acquires the data size of the image data.

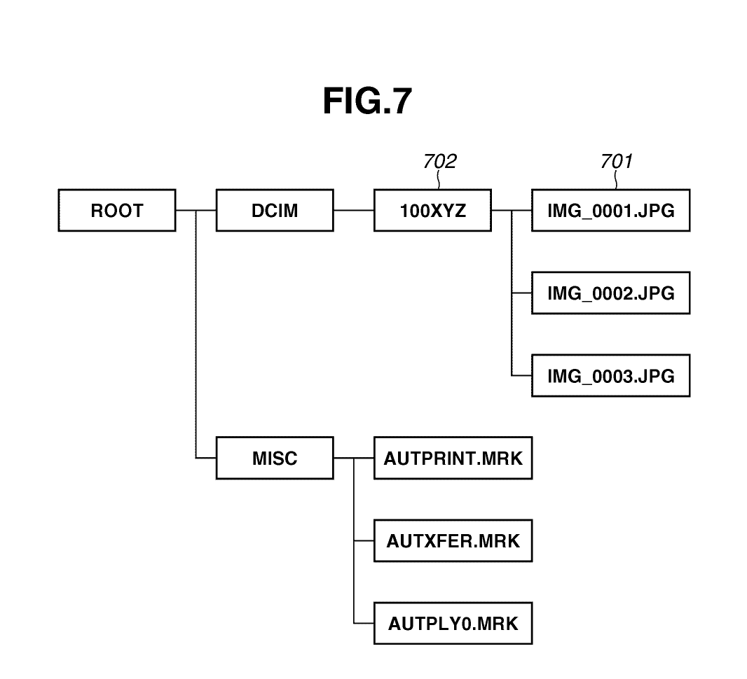

In step S604, the system control unit 50 determines whether a directory for storing the generated file exists in the recording medium 200. If the directory exists (YES in step S604), the process proceeds to step S606. On the other hand, if the directory does not exist (NO in step S604), the process proceeds to step S605. In step S605, the system control unit 50 generates the directory for storing the image data. FIG. 7 illustrates a state in which a directory “100XYZ” 702 for storing image data “IMG0001.JPG” 701 is generated in the recording medium 200.

Further, in step S605, the system control unit 50 generates a directory entry using the file name generated in step S601 and the date and time information acquired in step S602. In step S606, the system control unit 50 generates a file header including shooting conditions such as shooting date and time, with respect to the image data stored in the memory 32 in the shooting process. The configuration of the image file generated as described above will be described below.

In step S607, the system control unit 50 determines whether the image data stored in the memory 32 has been captured as part of related image data (i.e., captured as a related image). The system control unit 50 determines based on the setting of the operation unit 70 and the setting position of the mode switch 60 for designating continuous shooting, bracketing shooting, stitch shooting, three-dimensional (3D) image shooting, and continuous shooting mode. If the image data is not captured as a related image (NO in step S607), the process proceeds to step S609. If the image data is captured as a related image (YES in step S607), the process proceeds to step S608.

In step S608, the system control unit 50 records in the file header generated in step S606, related image information between the series of captured data to be described below. In step S609, the system control unit 50 generates the image file based on the file header and the image data, and records the image file in the corresponding directory on the recording medium 200. The recording process then ends.

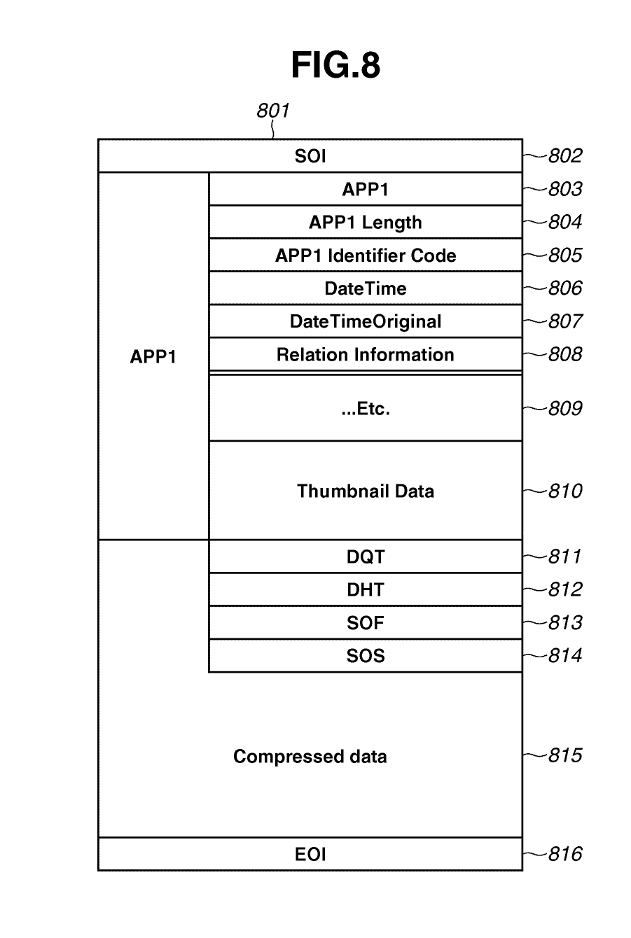

The file structure of the image data recorded on the recording medium 200 according to the above-described recording process will be described below with reference to FIG. 8. Referring to FIG. 8, an image file 801 includes at the top a start of image (SOI) marker 802 indicating start of the image, and an application marker segment APP1 to follow. The APP1 includes an application marker APP1 803, an APP1 length 804 indicating a size of the APPI, and an APP1 identifier code 805. Further, the APP1 includes DateTime 806 indicating date and time the image is generated, DateTimeOriginal 807 indicating date and time the image data is generated, RelationInformation 808 indicating a relation of the image, other shooting information 809, and a thumbnail image 810.

When the directory entry is generated in step S605 of the recording process illustrated in FIG. 6, the system control unit 50 stores in the DateTime 806 and DateTimeOriginal 807 the shooting date and time information stored in the system memory 52 in step S501 illustrated in FIG. 5. Further, the system control unit 50 describes in the RelationInformation 808 predetermined information indicating that there is a relation among a plurality of captured images. The predetermined information may be an image number for identifying an initial image among the series of related images, or information indicating that the image is one of the series of related images (e.g., shooting mode information). In other words, the information can be any information as long as the representative image can be determined using the related image information, as will be described below.

Further, as illustrated in FIG. 8, the image data to be recorded includes a quantization table DQT 811, a Huffman table DHT 812, a frame start marker SOF 813, a scan start marker SOS 814, and compressed data 815. The image data ends with a marker EOI 817 indicating the end of the image data. The file structure illustrated in FIG. 8 is defined according to the Exchangeable Image File Format (Exif) standard, and can be recognized as an Exif structure by referring to the APP1 code (803) and the APPI identifier code (805).

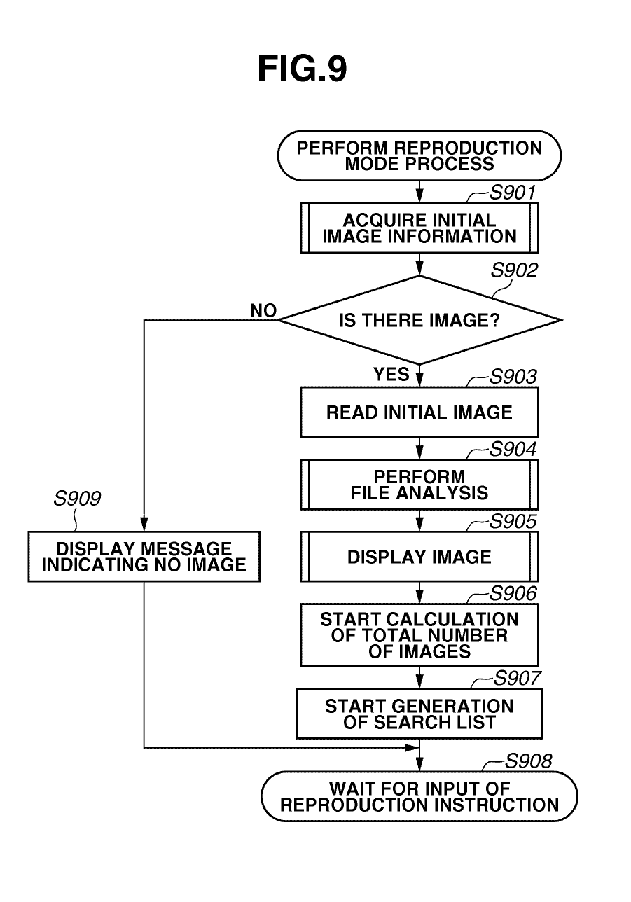

FIG. 9 is a flowchart illustrating a process performed in the reproduction mode. When the user instructs reproduction via the mode switch 60, the reproduction mode is started. Further, if the user switches on and activates the digital camera 100 while the digital camera 100 is set to the reproduction mode, the process illustrated in FIG. 9 is started.

In step S901, the system control unit 50 acquires from the recording medium 200 initial image information. The initial image is the latest image or the image displayed in previous reproduction. The system control unit 50 acquires the initial image information before calculating the total number of images and generating a search list to be described below. The digital camera 100 can thus display the initial image immediately after entering the reproduction mode, and can prevent not displaying any image to the user and causing the user to wait while performing a process such as calculating the total number of images. The initial image information acquisition process performed in step S901 will be described in detail below.

In step S902, the system control unit 50 determines whether the initial image information has been correctly acquired in step S901. Since there is a case where there is no image or the image information cannot be acquired due to a failure in the recording medium, such a determination is performed. When the initial image information can be acquired, it is determined that there is at least one image. If there is an image (YES in step S902), the process proceeds to step S903. If there is no image (NO in step S902), the process proceeds to step S909.

In step S903, the system control unit 50 reads from the recording medium 200 the initial image, based on the initial image information acquired in step S901. In step S904, the system control unit 50 performs file analysis to analyze the shooting information and attribute information of the read initial image, and checks whether the image data is not destructed.

In step S905, the system control unit 50 displays the read initial image, and also displays the shooting information and the attribute information as necessary. Further, if it is analyzed as a result of the file analysis performed in step S904 that the data is improper data, such as a portion of the initial image file is destructed, the system control unit 50 displays an error message.

In step S906, the system control unit 50 starts calculating the total number of images recorded in the recording medium 200, and acquires the total number of images. Such a process is asynchronously performed with respect to displaying of the image, and the next image can be displayed without waiting for the calculation to be completed. As a result, the user can view the image even when there are a large number of images recorded on the recording medium 200 and time is necessary to calculate the total number of images.

In step S907, the system control unit 50 starts generating the search list as a result of the search performed by analyzing all of the images in the recording medium 200. The search list collectively manages the previously acquired attribute information added to each of the images. By generating the search list, the images having a predetermined attribute may be collectively reproduced or deleted. The search list is asynchronously generated with respect to displaying of the image, similarly as the calculation of the total number of images, so that the next image can be displayed. In step S908, the system control unit 50 waits for a reproduction input from the user.

If the system control unit determines that there is no image (NO in step S902), the process proceeds to step S909. In step S909, the system control unit 50 displays a message such as “no image” on the image display unit 28 to indicate that there is no image, and the process then proceeds to step S908.

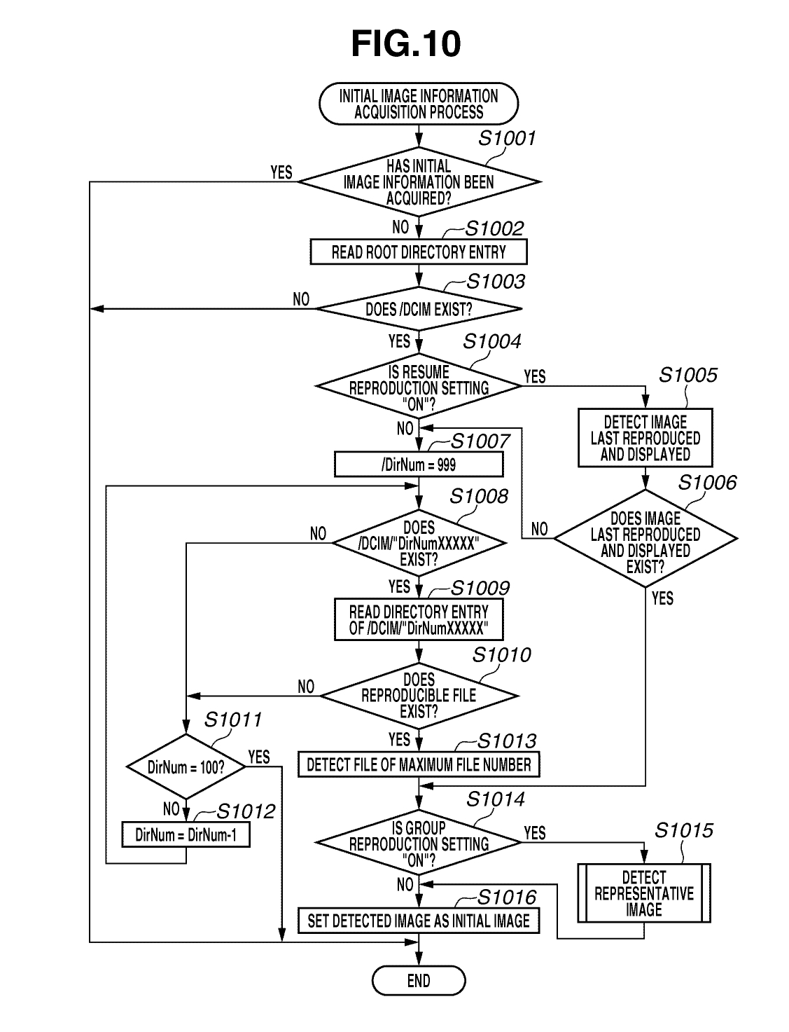

FIG. 10 is a flowchart illustrating the initial image information acquisition process performed in step S901 of the reproduction mode process illustrated in FIG. 9.

In step S1001, the system control unit 50 determines whether the initial image information has been acquired. If the initial image information has been acquired (YES in step S1001), the process ends. If the initial image information has not been acquired (NO in step S1001), the process proceeds to step S1002.

In step S1002, the system control unit 50 reads a root directory entry from the recording medium 200. In step S1003, the system control unit 50 analyzes the root directory entry read out in step S1002, and determines whether a digital camera image (“/DCIM”) directory exists. If the “/DCIM” directory does not exist (NO in step S1003), the system control unit 50 determines that there is no image to be reproduced, and the process ends. If the “/DCIM” directory exists (YES in step S1003), the process proceeds to step S1004.

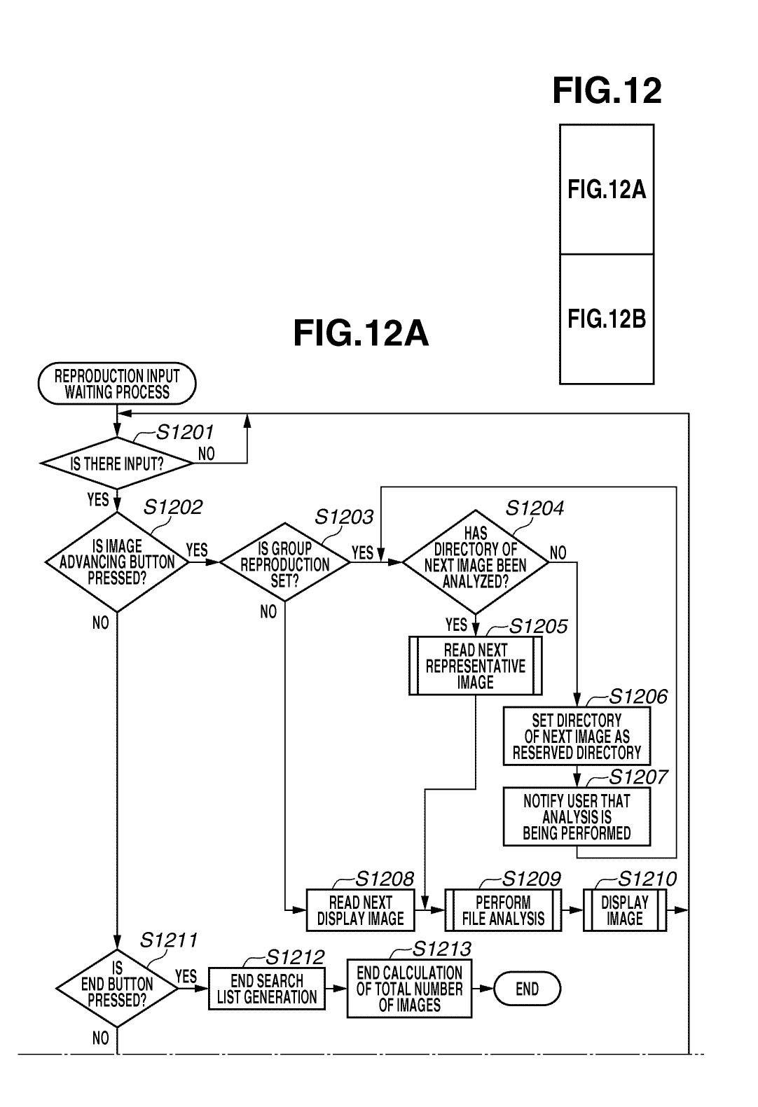

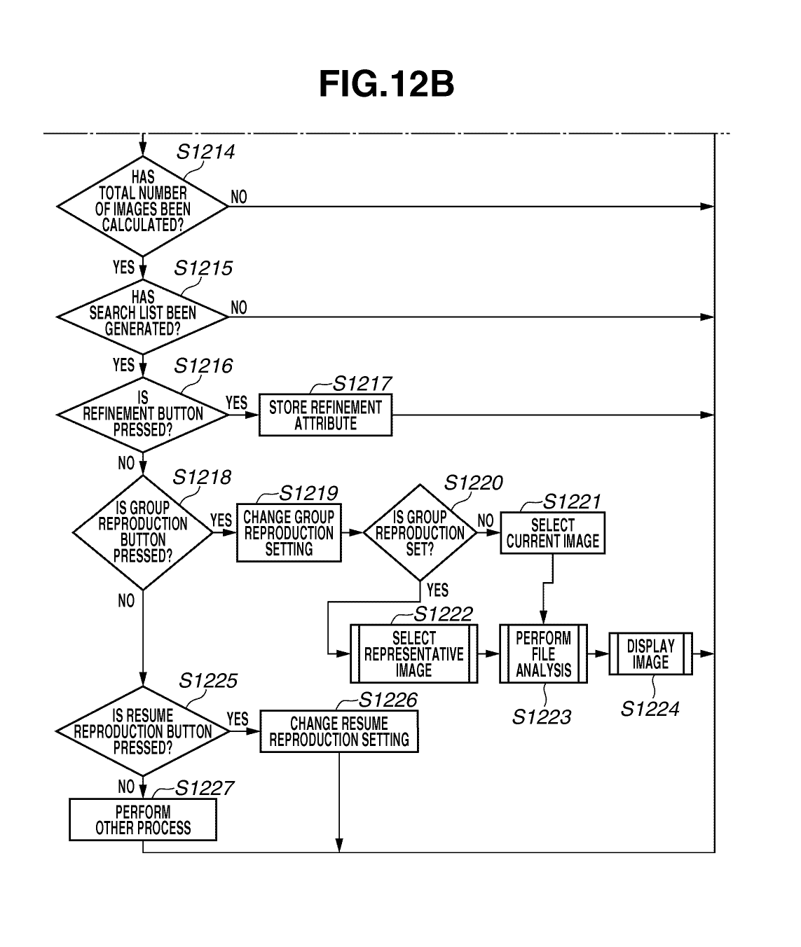

In step S1004, the system control unit 50 determines whether a resume reproduction setting is “on”. The system control unit 50 determines based on the resume reproduction setting specified in step S1229 of a reproduction input wait process illustrated in FIG. 12 to be described below. If the resume reproduction setting is “on” (YES in step S1004), the process proceeds to step S1005.

In step S1005, the system control unit 50 detects and reads the image that has been last reproduced and displayed. Such a process corresponds to an example of the process performed by an image reading unit. In step S1006, the system control unit 50 determines whether there is the image that has been last reproduced and displayed. If there is such an image (YES in step S1006), the process proceeds to step S1014. If there is no such image (NO in step S1006), the process proceeds to step S1007.

On the other hand, if the resume reproduction setting is “off” (NO in step S1004), the process proceeds to step S1007. In step S1007, the system control unit 50 reads the “/DCIM” directory, and sets a search directory number to “999”, i.e., a maximum value in the Design rule for Camera File system (DCF) standard. In step S1008, the system control unit 50 determines whether there is a directory having the set directory number. If there is such a directory (YES in step S1008), the process proceeds to step S1009. In step S1009, the system control unit 50 reads out the directory entry of the set directory number.

In step S1010, the system control unit 50 determines whether there is a reproducible image. If DirNum in the directory /DCIM/“DirNumXXXXX” described in step S1008 and step S1009 is “100”, the directory /DCIM/“DirNumXXXXX” becomes /DCIM/100XXXXX. “XXXXX” is a five-letter ASCII one-byte alphabet and numbers.

If there is no reproducible file (NO in step S1010), the process proceeds to step S1011. In step S1011, the system control unit 50 determines whether DirNum is “100”, i.e., a minimum value according to the DCF standard. If DirNum is not 100 (NO in step S1011), the process proceeds to step S1012. In step S1012, the system control unit 50 searches the directory which is one less than DirNum.

On the other hand, if a reproducible files exists (YES in step S1010), the process proceeds to step S1013. In step S1013, the system control unit 50 detects in and reads from the directory the file having the largest number among the reproducible files. Such a process corresponds to an example of the process performed by the image reading unit.

In step S1014, the system control unit 50 determines whether a group reproduction setting is “on”. The group reproduction setting is specified based on whether the user operates on the group reproduction setting button in step S1218 of the reproduction input wait process illustrated in FIG. 12 to be described below. If the group reproduction setting is “on” (YES in step S1014), the process proceeds to step S1015. In step S1015, the system control unit 50 performs a representative image detection process to be described below. In step S1016, the system control unit 50 sets the detected representative image as the initial image, and the process ends.

If the group reproduction setting is “off” (NO in step S1014), the process proceeds to step S1016. In step S1016, the system control unit 50 sets the file of the largest number detected in step S1013 as the initial image, and the process ends.

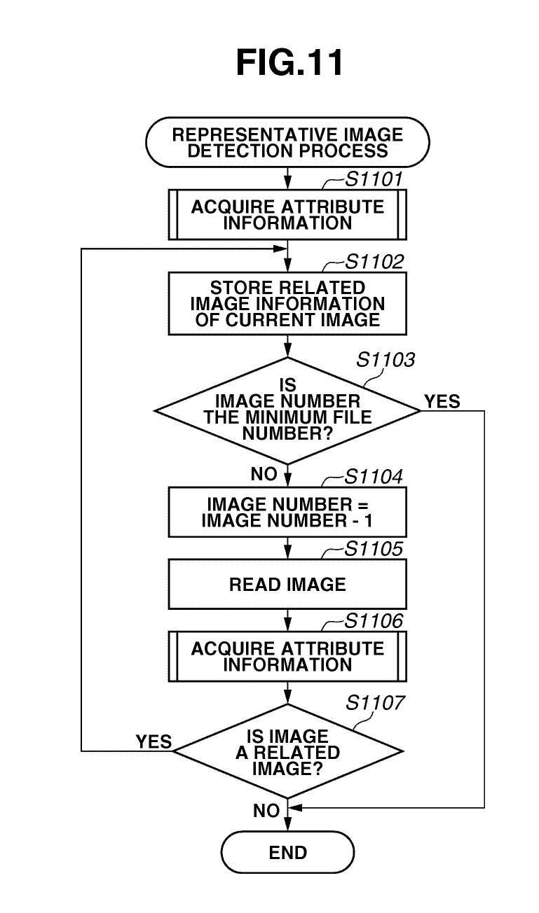

FIG. 11 is a flowchart illustrating the representative image detection process performed in step S1015 of the initial image information acquisition process illustrated in FIG. 10.

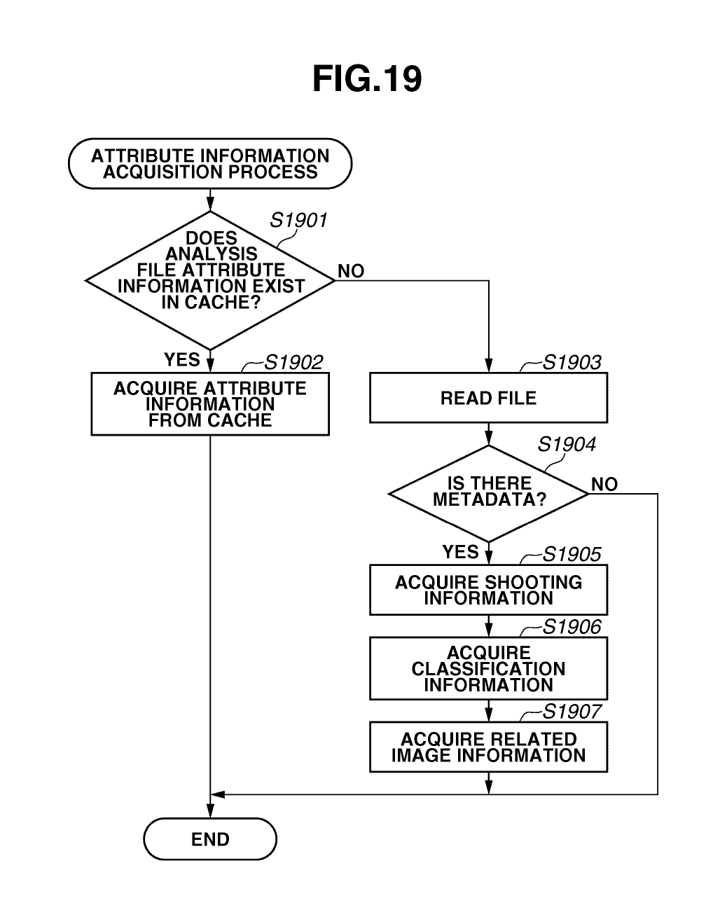

In step S1101, the system control unit 50 acquires the attribute information of the image that is currently being read. The process is performed according to an attribute information acquisition process illustrated in FIG. 19 to be described below. If the reproduction process has been started, the image which is currently being read may be the image that has been last reproduced and displayed or the image of the largest number in the largest directory as the image, that has been resume-reproduced in the initial image information acquisition process illustrated in FIG. 10.

By performing the process of step S1101, the system control unit 50 can acquire the related image information. The process corresponds to an example of the process performed by a related image determination unit. The related image information is the information indicated by RelationInformation 808 in the image data file illustrated in FIG. 8. As described above, the related image information may be the image number for identifying the initial image among the series of related images, or information indicating that the image configures one of the series of related images. In step S1102, the system control unit 50 temporarily stores in the system memory 52 the related image information of the image being currently detected, to be used in comparing with the attribute information of the image to be subsequently read.

In step S1103, the system control unit 50 determines whether the image number of the current image is the smallest number (i.e., a minimum file number). If the image number is the smallest number (YES in step S1103), the system control unit 50 stores in the system memory 52 the image of the current image number as the representative image, and the process ends. If the image number is not the smallest number (NO in step S1103), the process proceeds to step S1104.

In step S1104, system control unit 50 decrements the image number by one. In step S1105, the system control unit 50 detects and reads the image of the decremented image number. In step S1106, the system control unit 50 acquires the attribute information of the read image.

In step S1107, the system control unit 50 determines whether the previous image stored in the system memory 52 is related to the image which is currently being read. In other words, the system control unit 50 determines whether the previous image is included as the related image in the same group, such as a series of images acquired by performing one continuous shooting.

If the previous image is a related image (YES in step S1107), the process returns to step S1102, and the system control unit 50 stores in the system memory 52 the related image information of the image read in step S1105. In step S1103, the system control unit 50 then repeats the process until the image number becomes the smallest number, or until the system control unit 50 detects an image that is not a related image.

On the other hand, if the previous image is not a related image (NO in step S1107), the system control unit 50 stores in the system memory 52, the image corresponding to the related image information stored in the system memory 52 in step S1102, as the representative image. The process then ends. By performing the process illustrated in FIG. 11, the top image among the related images can be selected.

As described above, the representative image is detected by comparing the related image information among the images. The process then returns to the initial image information acquisition process illustrated in FIG. 10. In step S1016, the system control unit 50 sets the detected representative image as the initial image.

FIG. 12, which is composed of FIGS. 12A and 12B, is a flowchart illustrating the reproduction input wait process performed in step S908 of the reproduction mode process illustrated in FIG. 9.

In step S1201, the system control unit 50 determines whether there is an input from the user. An “input” in step S908 includes a user operation on the operation unit 70 or the slot cover 202, an event informing of low power, and a completion notice on the search list generation process which is started when the digital camera 100 is activated. The system control unit 50 waits for such an input, and if there is an input (YES in step S1201), the process proceeds to step S1202.

In step S1202, the system control unit 50 determines whether the input is an operation on an image advancing button. If the input is an operation on the image advancing button (YES in step S1202), the process proceeds to step S1203. In step S1203, the system control unit 50 determines whether the group reproduction setting is “on”.

If the group reproduction setting is “off” (NO in step S1203), the process proceeds to step S1208. In step S1208, the system control unit 50 reads the image to be displayed next in the order of the file numbers. In such a case, the system control unit 50 does not skip the related images other than the representative image. The image advancing button is formed in opposite directions, and the order of the image to be next displayed according to an advancing direction changes between a forward direction and a backward direction.

In step S1209, the system control unit 50 performs file analysis to be described below. In step S1210, the system control unit 50 displays the read image, and also displays the shooting information and the attribute information according to the setting. Furthermore, if the system control unit 50 analyzes as a result of the file analysis performed in step S1209 that there is improper data in which a portion of the display image file is destructed, the system control unit 50 may display an error message. The process then returns to an input waiting state in step S1201.

On the other hand, if the group reproduction setting is “on” (YES in step S1203), the process proceeds to step S1204. In step S1204, the system control unit 50 determines whether the directory including the read image has been analyzed. If the directory has been analyzed in the directory analysis process performed in the initial image acquisition process illustrated in FIG. 10 (YES in step S1204), the process proceeds to step S1205.

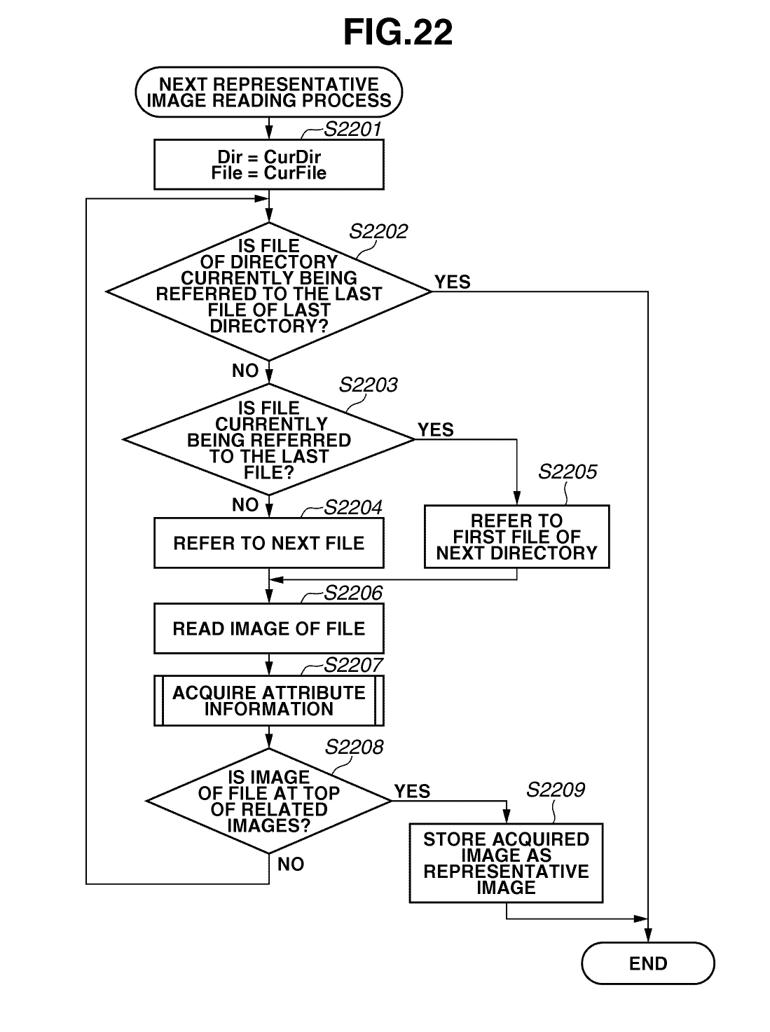

In step S1205, the system control unit 50 reads the next representative image. In step S1209, the system control unit 50 then performs the file analysis, and in step S1210, the system control unit 50 displays the image. The process of reading the next representative image performed in step S1205 will be described below with reference to FIG. 22.

If the directory including the next image has not been analyzed (NO in step S1204), the process proceeds to step S1206. In step S1206, the system control unit 50 stores in the system memory 52 the directory including the read image as a reserved directory, and performs directory analysis of the reserved directory in the background. In step S1207, the system control unit 50 displays on the image display unit 28 a message or an icon indicating to the user that the analysis is being performed. The process then returns to step S1204 in which the system control unit 50 again determines whether the directory has been analyzed. The reserved directory set in step S1206 is preferentially analyzed in the search list generation process to be described below.

If the input is not a user operation on the image advancing button (NO in step S1202), the process proceeds to step S1211. In step S1211, the system control unit 50 determines whether the input is a user operation on the end button. If the input is a user operation on the end button (YES in step S1211), the process proceeds to step S1212. In step S1212, the system control unit 50 ends the search list generation process. If the system control unit 50 is in the middle of generating the search list, the system control unit 50 suspends the process. If the system control unit 50 has completed generating the search list, the system control unit 50 does not perform any process.

In step S1213, the system control unit 50 ends calculating the total number of images. If the system control unit 50 is in the middle of calculating the total number of images, the system control unit 50 suspends the process. If the system control unit 50 has calculated the total number of images, the system control unit 50 does not perform any process. This is similar to the process performed in step S1212. The system control unit 50 then ends the reproduction mode process, and the process returns to the shooting mode process performed in step S303 illustrated in FIG. 3.

If the system control unit 50 determines that the input is not a user operation on the end button (NO in step S1211), the process proceeds to step S1214. In step S1214, the system control unit 50 determines whether the calculation of the total number of images performed in step S906 illustrated in FIG. 9 has been completed. If the calculation of the total number of images has not been completed (NO in step S1214), the process returns to step S1201, and the system control unit 50 waits for an input. In such a case, the system control unit 50 may display on the image display unit 28 a message or an icon indicating that the calculation of the total number of images has not been completed.

If the calculation of the total number of images has been completed (YES in step S1214), the process proceeds to step S1215. In step S1215, the system control unit 50 determines whether the search list generation performed in step S907 illustrated in FIG. 9 has been completed. If the search list generation has not been completed (NO in step S1215), the process returns to step S1201, and the system control unit 50 waits for an input. In such a case, the system control unit 50 may display on the image display unit 28 a message or an icon indicating that the search list generation has not been completed, similarly as in the case where the total number of images has not been completed.

If the search list generation has been completed (YES in step S1215), the process proceeds to step S1216. In step S1216, the system control unit 50 determines whether the input is a user operation on a refinement button. If the input is a user operation on the refinement button (YES in step S1216), the process proceeds to step S1217. In step S1217, the system control unit 50 stores a refining attribute selected by the user using the refinement button. The process then returns to step S1201, and the system control unit 50 waits for an input.

On the other hand, if the input is not a user operation on the refinement button (NO in step S1216), the process proceeds to step S1218. In step S1218, the system control unit 50 determines whether the input is a user operation on a group reproduction button. If the input is a user operation on the group reproduction button (YES in step S1218), the process proceeds to step S1219. In step S1219, the system control unit 50 changes an “on” state or an “off” state of the group reproduction setting.

In step S1220, the system control unit 50 determines whether the group reproduction setting is “on”. If the group reproduction setting is “on” (YES in step S1220), the process proceeds to step S1222. In step S1222, the system control unit 50 performs a representative image selection process to be described below. In step S1223, the system control unit 50 performs the file analysis, and in step S1224, the system control unit 50 displays the file. The process then returns to step S1201, and the system control unit 50 waits for an input.

If the group reproduction setting is “off” (NO in step S1220), the process proceeds to step S1221. In step S1221, the system control unit 50 selects the image that has been displayed as the representative image in the previous group reproduction as the image currently being displayed. In step S1223, the system control unit 50 performs the file analysis, and in step S1224, the system control unit 50 displays the image. The process then returns to step S1201, and the system control unit 50 waits for an input.

If the input is not a user operation on the group reproduction button (NO in step S1218), the process proceeds to step S1225. In step S1225, the system control unit 50 determines whether the input is a user operation on a resume reproduction button. If the input is an operation on the resume reproduction button (YES in step S1225), the process proceeds to step S1226. In step S1226, the system control unit 50 changes the “on” state or the “off” state of the resume reproduction setting. The process then returns to step S1201, and the system control unit 50 waits for an input. When the above-described resume reproduction setting is “on”, the system control unit 50 acquires and displays the last reproduced image in step S1005 of the initial image information acquisition process illustrated in FIG. 10.

If the input is not an operation on the resume reproduction button (NO in step S1225), the process proceeds to step S1227. In step S1227, the system control unit 50 performs the processes according to another input. For example, the system control unit 50 switches to multi-reproduction, or displays a menu according to a user operation on the menu button.

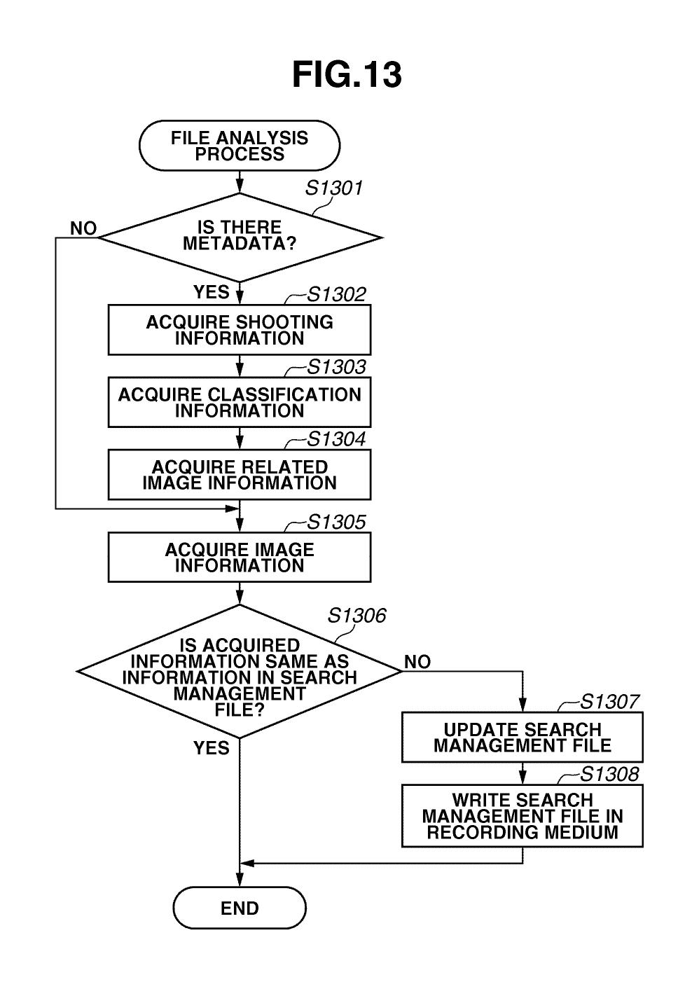

FIG. 13 is a flowchart illustrating the file analysis process performed in step S904 of the reproduction mode process illustrated in FIG. 9, and step S1209 and step S1223 of the reproduction input wait process illustrated in FIG. 12.

In step S1301, the system control unit 50 determines whether metadata of the attribute information, such as the shooting information, classification information, and the related image information, is described in the file to be analyzed. If there is no metadata (NO in step S1301), the process proceeds to step S1305. If there is metadata (YES in step S1301), the process proceeds to step S1302.

In step S1302, the system control unit 50 acquires the shooting information from the metadata. The shooting information is information about the shooting date and time, and the shooting mode employed when performing shooting.

In step S1303, the system control unit 50 acquires the classification information from the metadata. The classification information is identification information used in performing image search, such as tag information.

In step S1304, the system control unit 50 acquires the related image information from the metadata. The related image information is the information indicating that the image is captured by performing a series of the shooting process, such as continuous shooting, bracket shooting, stitch shooting, 3D image shooting, and in the continuous shooting mode, as described above. In those shooting modes, a great number of continuous images are frequently captured. Thus, it is greatly desirable that a plurality of images captured in such a shooting mode should be collectively managed.

In step S1305, the system control unit 50 acquires from the file the information about the file format of the image, and the image information on the image data itself, such as a start position of the image and an image compression method, that are extracted based on the file format.

In step S1306, the system control unit 50 determines whether the acquired shooting information, classification information, and image information are the same as the content of a search management file. If the acquired types of information are the same as the content of the search management file (YES in step S1306), the file analysis ends. On the other hand, if the acquired types of information are not the same as the content of the search management file (NO in step S1306), the process proceeds to step S1307.

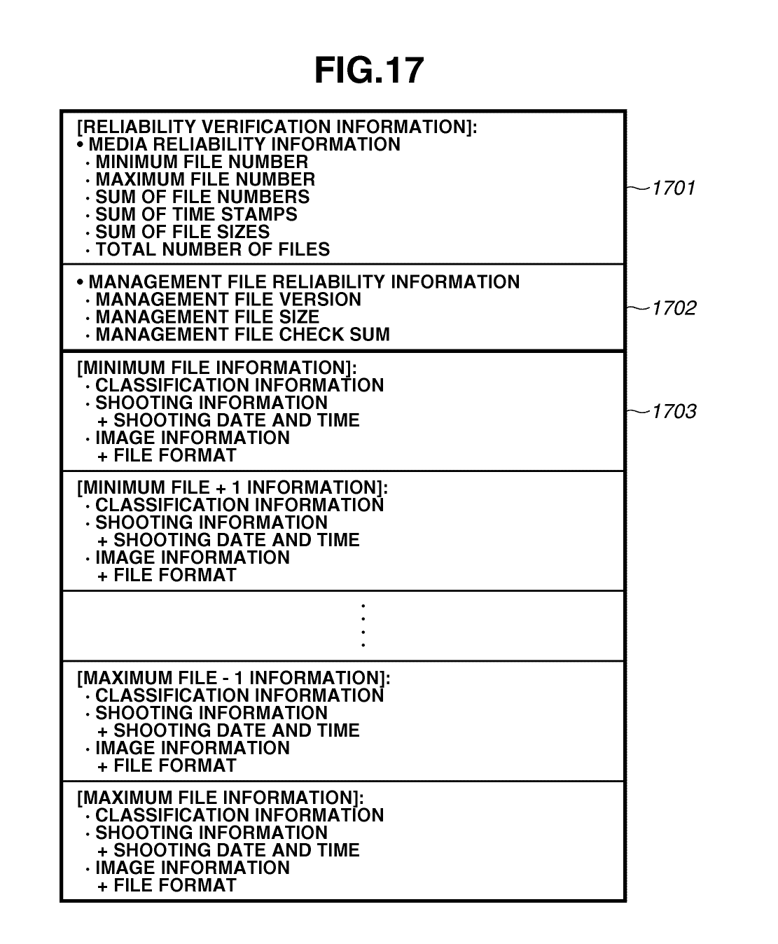

In step S1307, the system control unit 50 updates the search management file to match the acquired file information. The search management file will be described in detail below with reference to FIG. 17. In step S1308, the system control unit 50 writes the search management file on the recording medium 200, and the file analysis ends.

As described above, when reproducing the image, the system control unit 50 analyzes the read header of the file, and at the same time performs verification for each search management file. The search management file can thus be verified and corrected in detail without extra processing time. Further, the search management file can be reconstructed to a correct value even when falsification of the search management file or a change in the file to be managed cannot be detected.

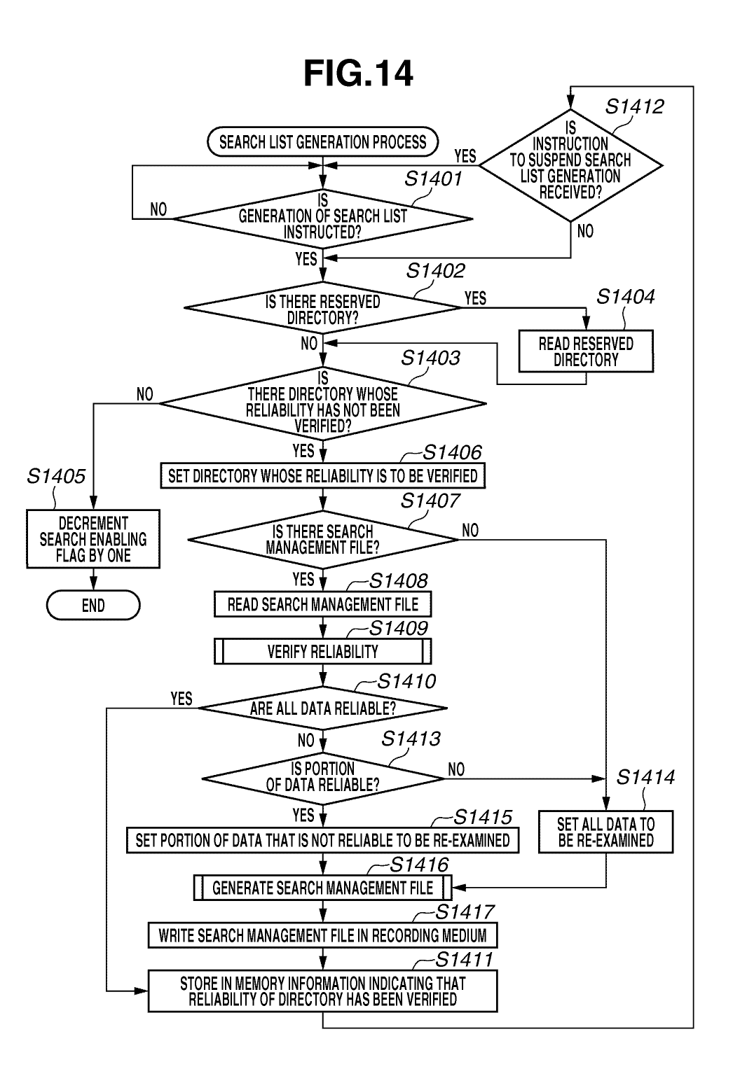

FIG. 14 is a flowchart illustrating the search list generation process performed in step S907 of the reproduction mode process illustrated in FIG. 9. The search list generation process includes a process for analyzing whether the image data is reliable, for all of the image data.

In step S1401, the system control unit 50 determines whether there is an instruction to generate the search list. If there is such an instruction (YES in step S1401), the process proceeds to step S1402. If there is no instruction (NO in step S1402), the system control unit 50 waits to receive the instruction.

In step S1402, the system control unit 50 determines whether there is a reserved directory. If there is no reserved directory (NO in step S1402), the process proceeds to step S1403. If there is a reserved directory (YES in step S1402), the process proceeds to step S1404. In step S1404, the system control unit 50 reads the reserved directory. The reserved directory is a directory set when the system control unit 50 determines in step S1204 of the reproduction input wait process illustrated in FIG. 12 that the directory including the image which has been image-advanced has not been analyzed.

In step S1403, the system control unit 50 determines whether there is a directory whose reliability has not been verified. If the reliability has been verified for all directories to be reproduced (NO in step S1403), the process proceeds to step S1405. In step S1405, the system control unit 50 sets a search enabling flag to “1”, stores the flag in the system memory 52, and the process ends. On the other hand, if there is a directory whose reliability has not been verified (YES in step S1403), the process proceeds to step S1406. In step S1406, the system control unit 50 sets the directory as a directory whose reliability is to be verified.

In step S1407, the system control unit 50 determines whether the search management file corresponding to the directory whose reliability is to be verified exists in the recording medium 200. If the search management file exists (YES in step S1407), the process proceeds to step 1408. In step S1408, the system control unit 50 reads the search management file to the system memory 52. In step S1409, the system control unit 50 verifies the reliability with respect to the search management file. The reliability verification process will be described below.

In step S1410, the system control unit 50 determines, as a result of performing the verification, whether all of the data is reliable. If all of the data is reliable (YES in step S1410), the process proceeds to step S1411. In step S1411, the system control unit 50 stores in the system memory 52 information indicating that the reliability of the directory has been verified. In step S1412, the system control unit 50 determines whether there is an instruction to suspend generation of the search list.

On the other hand, if it is determined that at least a portion of the data is not reliable (NO in step S1410), the process proceeds to step S1413. In step S1413, the system control unit 50 determines whether a portion of the data is reliable. If a portion of the data is reliable (YES in step S1413), the process proceeds to step S1415. If none of the data is reliable (NO in step S1413), and if it is determined that there is no search management file in the recording medium 200 (NO in step S1407), the process proceeds to step S1414. In step S1414, the system control unit 50 generates the search management files by setting all of the data in the directory to be re-examined.

In step S1415, the system control unit 50 sets the portion of the data whose reliability has not been verified as the data to be re-examined. In step S1416, the system control unit 50 generates the search management files with respect to the files set for re-examination. In step S1417, the system control unit 50 writes the generated search management files in the recording medium 200.

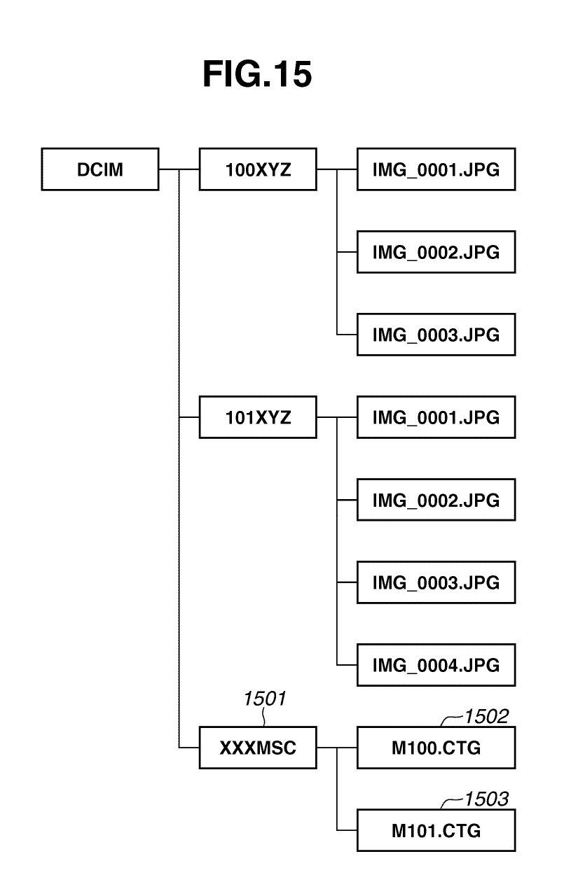

Referring to the tree structure in the recording medium illustrated in FIG. 15, the system control unit 50 generates a directory XXXMSC 1501 for storing the search management file. The system control unit 50 then stores the generated search management files (i.e., M100.CTG and M101.CTG) in the directory 1501. According to the present exemplary embodiment, the search management files are generated for each directory and stored as illustrated in FIG. 15. For example, M100.CTG 1502 is a search management file of a directory 100XYZ, and M101.CTG 1503 is a search management file of a directory 101XYZ.

In step S1411, the system control unit 50 stores in the system memory 52 information indicating that the reliability of the directory has been verified.

In step S1412, the system control unit 50 determines whether there is an instruction to suspend generation of the search list. If there is an instruction (YES in step S1412), the process returns to step S1401, and the system control unit 50 waits to receive an instruction to generate the search list again. If there is no instruction (NO in step S1412), the process returns to step S1402, and the system control unit 50 performs the above-described process until there is no directory whose reliability has not been verified.

If the system control unit 50 has verified the reliability for all directories to be reproduced (NO in step S1403), the process proceeds from step S1403 to step S1405. In step S1405, the system control unit 50 sets the search enabling flag to 1, and the process ends.

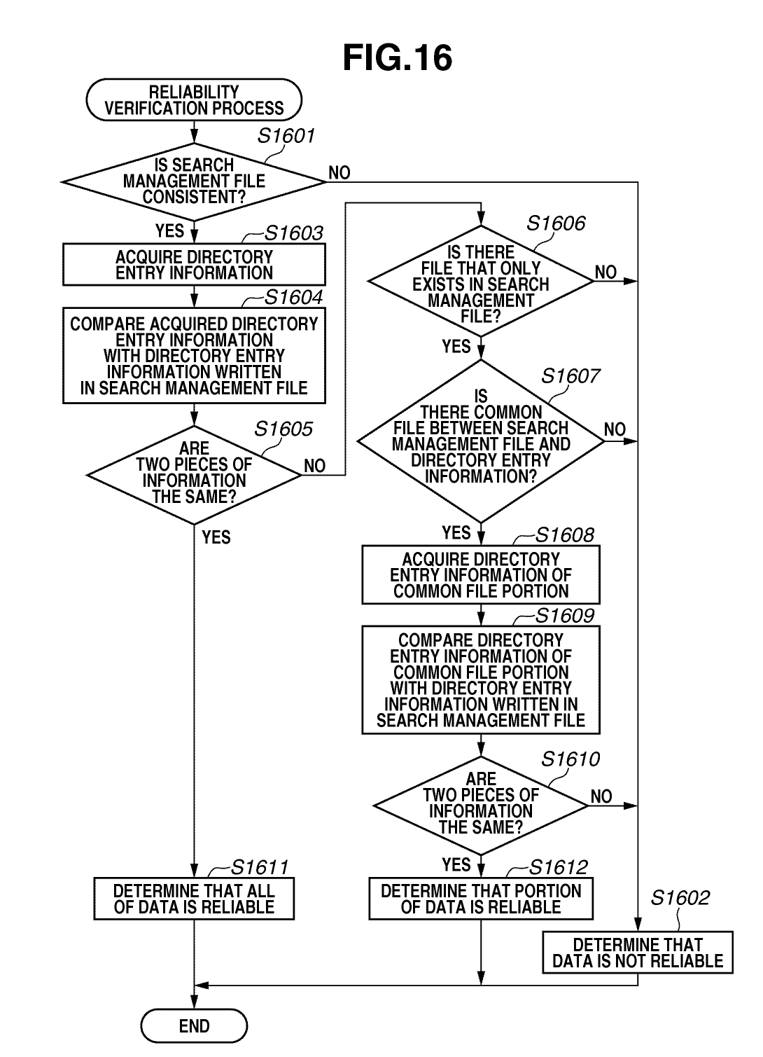

FIG. 16 is a flowchart illustrating the reliability verification process performed in step S1409 of the search list generation process illustrated in FIG. 14.

In step S1601, the system control unit 50 verifies the consistency of the search management file read from the recording medium 200 to the system memory 52 in step S1408 illustrated in FIG. 14.

FIG. 17 illustrates an example of a structure of the search management file. The process in step S1601 is performed according to search management file reliability information 1702 illustrated in FIG. 17. The management file reliability information 1702 includes a management file version, a management file size, and a management file checksum, which are information on the consistency of the search management file itself and not the search information in the search management file. The falsification of the search management file itself can thus be verified using the management file reliability information 1702. Further, a time stamp and a hash value can also be employed as the management file reliability information 1702.

If the consistency of the search management file cannot be verified (NO in step S1601), the process proceeds to step S1602. In step S1602, the system control unit 50 determines that the data is not reliable, and the process ends. Such a determination process prevents disabling a normal search from to be performed due to falsification of the search management file. On the other hand, if the consistency of the search management file is verified (YES in step S1601), the process proceeds to step S1603. In step S1603, the system control unit 50 acquires the directory entry information stored in the system memory 52.

In step S1604, the system control unit 50 compares the directory entry information written in the search management file read from the recording medium 200 in step S1408 illustrated in FIG. 14 with the directory entry information acquired in step S1603. In such a case, the comparison is performed using information indicating the configuration of the directory, as described in reliability verification information 1701 illustrated in FIG. 17.

Referring to FIG. 17, the reliability verification information 1701 includes a minimum file number, a maximum file number, a sum of the file numbers, a sum of the time stamp, a sum of the file size, and a total number of files. According to the present exemplary embodiment, it is assumed that the digital camera 100 conforms to the DCF standard, so that the file number is used as the directory entry information. However, the file name, a sum of character codes of the file names, and a hash value of the directory entry in the recording medium 200 may also be used as the directory entry information.

In step S1605, the system control unit 50 determines whether the two pieces of information are the same, based on the comparison result. If the two pieces of information are the same (YES in step 1605), the process proceeds to step S1611. In step S1611, the system control unit 50 determines that all of the data is reliable, and the process ends. In other words, the above-described process prevents disabling a normal search to be performed due to a change in the file itself stored in the subject directory or a change in the file configuration.

If the two pieces of information are not the same (NO in step S1605), the process proceeds to step S1606. In step S1606, the system control unit 50 determines whether there is a file which only exists in the search management file. If there is a file which only exists in the search management file (YES in step S1606), the process proceeds to step S1607. On the other hand, if there is no file which only exists in the search management file (NO in step S1606), the process returns to step S1602.

In step S1607, the system control unit 50 determines whether there is a common file which exists in both the search management file and the directory entry information. If there is such a common file (YES in step S1607), the process proceeds to step S1608. In step S1608, the system control unit 50 acquires from the recording medium 200 the directory entry information of the common file portion. In step S1609, the system control unit 50 compares the directory entry information of the common file portion with the directory entry information written in the search management file. The time stamp, the file size, the file name, a protect attribute, a hidden attribute, and an archive attribute can be used in performing comparison of the directory entry information.

In step S1610, the system control unit 50 determines whether the directory information of the common file portion is the same as the directory information written in the search management file. If the two pieces of directory information are the same (YES in step S1610), the process proceeds to step S1612. If the two pieces of directory information are not the same (NO in step S1610), the process proceeds to step S1602.

In step S1612, the system control unit 50 determines that a portion of the data is reliable, and the process ends. For example, if the user adds an image to the recording medium 200 from a PC, and the power is shut down before the image is reflected in the search management file in the digital camera 100, the information on a portion of the file may not be written in the search management file. According to the present exemplary embodiment, the data which has already been verified to be reliable can be effectively used even in such a case.

If the system control unit 50 determines that there is no common file (NO in step S1607), or that the information in the common file portion is not the same as the directory information written in the search management file (NO in step S1610), the process proceeds to step S1602. In step S1602, the system control unit 50 determines that the data is not reliable, and the process ends.

As described above, the system control unit 50 detects a change in the configuration of the file or a change in the file in the recording medium 200 by comparing with the data written in the directory entry instead of referring to the content of the file. The process can thus be performed at high speed.

Further, as illustrated in step S1406 to step S1417 of the search list generation process in FIG. 14, the search management file is reconstructed by setting only the portion of the data that is not reliable in the recording medium 200 as the data to be re-examined. The search management file is then generated for the set file. As a result, it is not necessary to uniformly generate the search management file by re-examining all of the data, so that the process can be performed at high speed.

Furthermore, as illustrated in step S1607 to step S1612 in the reliability verification process of FIG. 16, and in step S1415 of the search list generation process in FIG. 14, if there is no change in the common file, the information in the search management file of the common file can be directly used. The constructed search management file can thus be effectively used even when a device other than the digital camera 100 adds a file to the directory, or when the digital camera 100 adds a file to the directory and is switched off before updating the search management file.

Moreover, if there is no change in the common file, the search management files are reconstructed with respect to only the newly added files in the directories in which a change in the file configuration or a change in the file has been detected in the recording medium 200. It is thus not necessary to reconstruct the search management file for the constructed file information, and re-examination is only performed for the files detected to be added.

Further, as illustrated in step S1601 of the reliability verification process in FIG. 16, the reliability verification is also performed by writing the file attributes of the search management file itself (i.e., the management file reliability information 1702 illustrated in FIG. 17) in the search management file and verifying the file attributes. The falsification in the search management file itself can thus be detected, and an incorrect management can be prevented.

Furthermore, as illustrated in step S1604 to step S1610 in FIG. 16, the falsification in the search management file is confirmed using the information in the search management file itself and the information in the directory entry of the search management file. The process can thus be performed at high speed in each search management file.

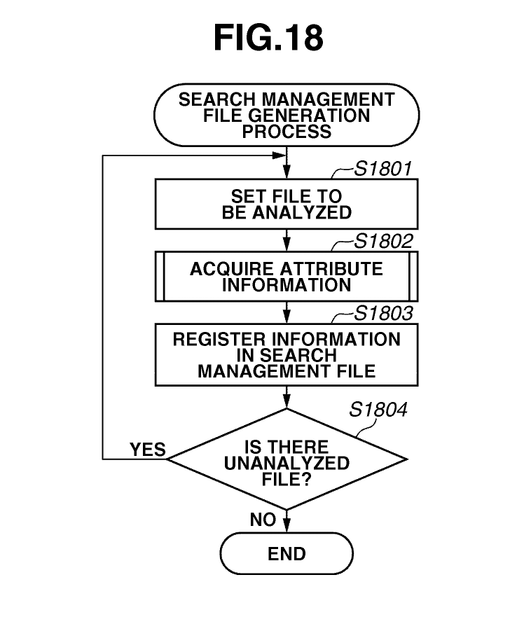

FIG. 18 is a flowchart illustrating the search management file generation process performed in step S1416 of the search list generation process illustrated in FIG. 14.

In step S1801, the system control unit 50 sets an analysis file, i.e., the file to be analyzed. The analysis file corresponds to the file that has not been analyzed among the portion of the files whose reliability cannot be verified set in step S1415 illustrated in FIG. 14, or all files in the directory set in step S1414 illustrated in FIG. 14.

In step S1802, the system control unit 50 acquires the attribute information of the file to be analyzed. In step S1803, the system control unit 50 generates the information to be written in the search management file based on the acquired attribute information, and then registers the information in the search management file.

Referring to FIG. 17, minimum file information 1703 is such file information. The minimum file information 1703 which includes the classification information, the shooting information, and object information is the information for identifying the file. For example, the file name and the file number may be written in the list as the information for identifying the file. Further, the information for identifying the file may be information indicating a listing order of the file.

In step S1804, the system control unit 50 determines whether there is an unanalyzed file. If there is an unanalyzed file (YES in step S1804), the process returns to step S1801. In step S1801, the system control unit 50 sets the unanalyzed file as the analysis file, and repeats the above-described process. If there is no unanalyzed file (NO in step S1804), the process ends.

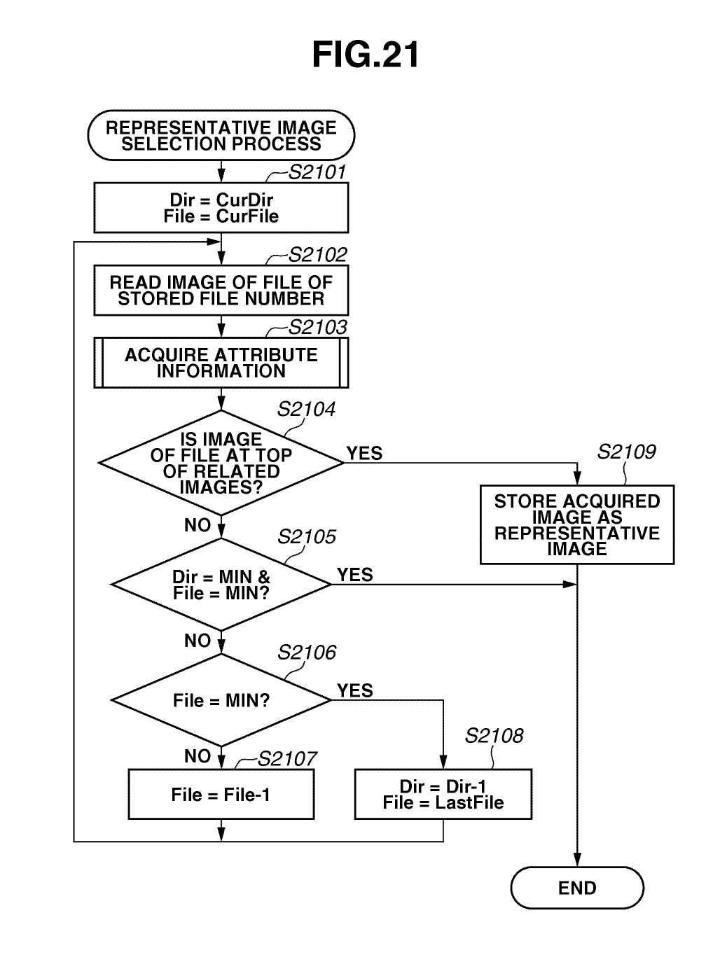

FIG. 19 is a flowchart illustrating the attribute information acquisition process performed in step S1101 and step S1106 of the representative image detection process illustrated in FIG. 11, step S1802 of the search management file generation process in FIG. 18, and step S2108 of a representative image selection process illustrated in FIG. 21 to be described below.

In step S1901, the system control unit 50 determines whether the attribute information of the file to be analyzed exists in a cache area in the system memory 52. For example, the attribute information is stored in the cache area in the system memory 52 when the image is captured. If the attribute information exists (YES in step S1901), the process proceeds to step S1902. In step S1902, the system control unit 50 acquires from the cache area the attribute information to be written in the search management file, and the process ends.

On the other hand, if the attribute information does not exist (NO in step S1901), the process proceeds to step S1903. In step S1903, the system control unit 50 reads the file to be processed from the recording medium 200. In step S1904, the system control unit 50 determines whether the metadata of the attribute information is written in the file to be processed.

If the metadata is written in the file (YES in step S1904), the process proceeds to step S1905. In step S1905, the system control unit 50 acquires the shooting information. In step S1906, the system control unit 50 acquires the classification information. In step S1907, the system control unit 50 acquires the related image information, and the process ends. If the metadata is not written in the file (NO in step S1904), the system control unit 50 ends the process.

As described above, if the attribute information is stored in the cache area of the system memory 52 when performing shooting, the process of reading the file from the recording medium 200 and analyzing the file to acquire the attribute information is not performed. The search management file can thus be constructed at high speed.

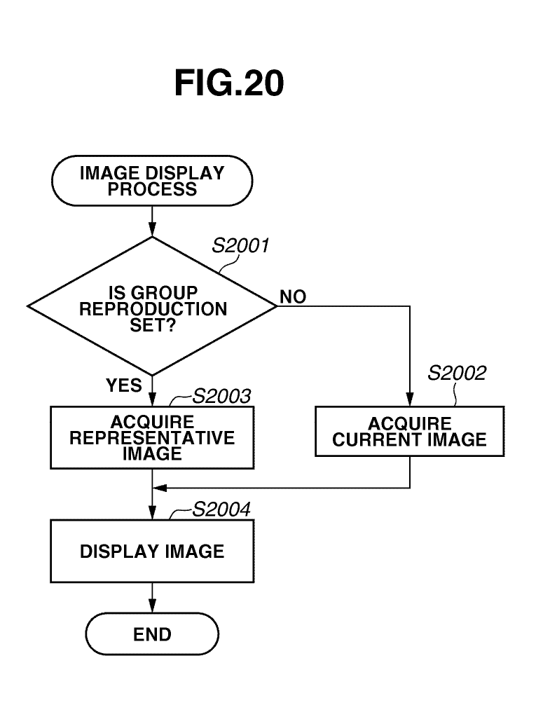

FIG. 20 is a flowchart illustrating the image display process performed in step S905 of the reproduction mode process illustrated in FIG. 9, and step S1210 and step S1224 of the reproduction input wait process illustrated in FIG. 12.

In step S2001, the system control unit 50 acquires from the system memory 52 the group reproduction setting, and determines whether the group reproduction setting is “on”. If the group reproduction setting is “off” (NO in step S2001), the process proceeds to step S2002. In step S2002, the system control unit 40 acquires the current image from the system memory 52.

If the group reproduction setting is “on” (YES in step S2001), the process proceeds to step S2003. In step S2003, the system control unit 50 acquires the representative image from the system memory 52. In step S2004, the system control unit 50 displays the acquired image or the representative image.

In the case where the representative image is to be displayed, the system control unit 50 displays, if the calculation of the total number of images is completed in step S904 illustrated in FIG. 9 and the search list generation is completed in step S907, a number of related image groups on the image display unit 28. The number of related image groups is a sum of the number of groups in which a group of related images is counted as one group, and an image that is not a related image is counted as one group. In other words, if the group reproduction is set, the number of groups corresponding to the number of images that can be displayed in the group reproduction is displayed instead of the total number of images as in the case where the group reproduction is not set.

FIG. 21 is a flowchart illustrating the representative image selection process performed in step S1222 of the reproduction input wait process illustrated in FIG. 12.

In step S2101, the system control unit 50 temporarily stores in the system memory 52 the directory number of the current directory and the file number of the image currently being displayed. In step S2102, the system control unit 50 reads the image of the file of the file number stored in step S2101. In step S2103, the system control unit 50 acquires the attribute information of the read image.

In step S2104, the system control unit 50 determines whether the image of the file number is the top image of the related images. If the image of the file number is the top image of the related images (YES in step S2104), the process proceeds to step S2109. In step S2109, the system control unit 50 records on the system memory 52 the read image as the representative image, and the process then ends.

If the image of the file number is not the top image of the related images (NO in step S2104), the process proceeds to step S2105. In step S2105, the system control unit 50 determines whether the directory number and the file number are both the minimum numbers. If the directory number and the file number are both the minimum numbers (YES in step S2105), the system control unit 50 does not record the representative image on the system memory 52, and the process ends.

If the directory number and the file number are not both the minimum numbers (NO in step S2105), the process proceeds to step S2106. In step S2106, the system control unit 50 determines whether the current file number is the minimum number in the directory. If the current file number is the minimum number in the directory (YES in step S2106), the process proceeds to step S2108. In step S2108, the system control unit 50 refers to the last file number in the directory whose number is one less than the current directory number. The process then returns to step S2102 and the system control unit 50 reads the image and continues to search for the top image of the related images.

If the current file number is not the minimum number in the directory (NO in step S2106), the process proceeds to step S2107. In step S2107, the system control unit 50 refers to the file number which is one less than the current file number. The process then returns to step S2102 and the system control unit 50 reads the image and continues to search for the top image of the related images.

FIG. 22 is a flowchart illustrating the next representative image reading process performed in step S1205 of the reproduction input wait process illustrated in FIG. 12. In the process to be described below, “last”, “first”, and “next” indicate different directories and files depending on the image advancing direction. More specifically, if the image is advanced so that the file number increases, “last” indicates the maximum number, “first” indicates the minimum number, and “next” indicates the number in the direction in which the image number increases. If the image is advanced so that the file number decreases, “last” indicates the minimum number, “first” indicates the maximum number, and “next” indicates the number in the direction in which the image number decreases.

In step S2201, the system control unit 50 reads from the system memory 52 the file number being currently displayed in the current directory. In step S2202, the system control unit 50 determines whether the file in the directory currently being referred to is the last file in the last directory among the data recorded on the recording medium. If the file in the directory currently being referred to is not the last file in the last directory (NO in step S2202), the process proceeds to step S2203. On the other hand, if the file in the directory currently being referred to is the last file in the last directory (YES in step S2202), the system control unit 50 does not record the representative image on the system memory 52, and the process ends.

In step S2203, the system control unit 50 determines whether the file currently being referred to is the last file. If the file currently being referred to is not the last file (NO in step 2203), the process proceeds to step S2204. In step S2204, the system control unit 50 refers to the next file number. In step S2206, the system control unit 50 reads the image file being referred to.

If the file currently being referred to is the last file (YES in step 2203), the process proceeds to step S2205. In step S2205, the system control unit 50 refers to the file of the first file number in the next directory. In step S2206, the system control unit 50 reads the file being referred to. In step S2207, the system control unit 50 then acquires the attribute information from the image file read in step S2206.

In step S2208, the system control unit 50 refers to the RelationInformation 808 among the acquired attribute information and determines whether the read image file is the top image of the related images. If it is determined based on the acquired attribute information that the read image file is the top image of the related images (YES in step S2208), the process proceeds to step S2209. In step S2209, the system control unit 50 records in the system memory 52 the acquired image as the representative image, and the process ends.

If it is determined based on the acquired attribute information that the read image file is not the top image of the related images (NO in step S2208), the process returns to step S2202. The system control unit 50 then refers to the RelationInformation 808 of the next image, and continues to search for the top image among the related images.

As described above, according to the present exemplary embodiment, the system control unit 50 determines if group reproduction is set, and whether the latest image or the image displayed in the last reproduction is an image among the related images. If the latest image or the image displayed in the previous reproduction is an image among the related images, the system control unit 50 sets the representative image as the initial image. The system control unit 50 then performs the file analysis on the set initial image and displays the initial image after completing the file analysis. As a result, if group reproduction is set, the representative image to be the initial image can be quickly searched and be viewed by the user without analyzing all of the images in the recording medium.

Further, if the analysis of the reliability verification has not been performed on the directory of the image to be read in response to the next reproduction instruction, the system control unit 50 preferentially analyzes the directory, even when group reproduction is set. The representative image can thus be quickly acquired from the series of related images and displayed, so that the time required before the user can view the image is shortened.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-022107 filed Feb. 3, 2011, which is hereby incorporated by reference herein in its entirety.

What is claimed is:

1. An image reproducing apparatus comprising:
an image reading unit configured to read an image from a recording unit;
a display processing unit configured to cause a display unit to display the image read by the image reading unit;
a related image determination unit configured to determine whether the image read by the image reading unit is an image included in a plurality of related images, which are related to each other;
a representative image detection unit configured to detect a representative image from the plurality of related images; and
a group reproduction setting unit configured to set group reproduction for reproducing only a representative image among the plurality of related images,
wherein, if the group reproduction is not set by the group reproduction setting unit, the display processing unit reproduces images read by the image reading unit, including images other than the representative image, and
wherein, if the group reproduction is set by the group reproduction setting unit, the related image determination unit determines whether the image read by the image reading unit is an image included in the plurality of related images, the representative image detection unit detects, when it is determined by the related image determination unit that the image read by the image reading unit is an image included in the plurality of related images, a representative image from a plurality of images constituting the plurality of related images including the read image, and the display processing unit causes the display unit to display the representative image detected by the representative image detection unit.

2. The image reproducing apparatus according to claim 1, wherein, if the image reproducing apparatus is activated in a state where the group reproduction is set by the group reproduction setting unit, the image reading unit reads a latest image among images recorded on the recording unit, and the representative image detection unit detects, when it is determined by the related image determination unit that the latest image is an image included in the plurality of related images, a representative image from a plurality of images constituting the plurality of related images including the latest image, and the display processing unit causes the display unit to display the detected representative image.

3. The image reproducing apparatus according to claim 2, further comprising:
an analysis unit configured to analyze an image; and
an analysis result recording unit configured to record, on a memory, a result of analyzing, by the analysis unit, all images recorded on the recording unit,
wherein the analysis unit analyzes an image recorded on the recording unit after the display processing unit causes the display unit to display the representative image of the plurality of related images including the latest image, and
wherein the analysis result recording unit records, on the memory, analysis results of all images recorded on the recording unit.

4. The image reproducing apparatus according to claim 3, wherein, when the analysis unit has analyzed all images recorded on the recording unit, the display processing unit causes, if the group reproduction is set by the group reproduction setting unit, the display unit to display a number of groups, and, if the group reproduction is not set by the group reproduction setting unit, the display unit to display a total number of images.

5. The image reproducing apparatus according to claim 4, wherein the number of groups is a total number of groups in which a group of images constituting a plurality of related images is counted as one group, and one image that is not a related image is counted as one group.

6. The image reproducing apparatus according to claim 1, further comprising a resume reproduction setting unit configured to set resume reproduction for performing reproduction starting with a last reproduced image according to a reproduction instruction input to the display unit,
wherein, if the group reproduction is set by the group reproduction setting unit and the resume reproduction is set by the resume reproduction setting unit, the image reading unit reads from the recording unit the last reproduced image according to the reproduction instruction input to the display unit, and the related image determination unit determines whether the last reproduced image read by the image reading unit is a related image.

7. The image reproducing apparatus according to claim 1, wherein the plurality of related images includes a series of images captured by performing continuous shooting, bracketing shooting, stitch shooting, or three-dimensional (3D) image shooting.

8. An image reproducing method for an image reproducing apparatus, the image reproducing apparatus including an image reading unit configured to read an image from a recording unit, a display processing unit configured to cause a display unit to display the image read by the image reading unit, a related image determination unit configured to determine whether the image read by the image reading unit is an image included in a plurality of related images, which are related to each other, a representative image detection unit configured to detect a representative image from the plurality of related images, and a group reproduction setting unit configured to set group reproduction for reproducing only a representative image among the plurality of related images, the image reproducing method comprising:
reproducing images, if the group reproduction is not set by the group reproduction setting unit, read by the image reading unit, including images other than the representative image;
determining, if the group reproduction is set by the group reproduction setting unit, whether the image read by the image reading unit is an image included in the plurality of related images;
detecting, when it is determined by the related image determination unit that the image read by the image reading unit is an image included in the plurality of related images, a representative image from a plurality of images constituting the plurality of related images including the read image; and
causing the display unit to display the representative image detected by the representative image detection unit.
